(19) United States
(12) Patent Application Publication
(10) Pub. No.: US 2010/0332356 A1
(43) Pub. Date: Dec. 30, 2010

(54) SYSTEM FOR PURCHASING COMMERCIAL GOODS AND SERVICES AT A LOCATION REMOTE THEREFROM

(76) Inventor: Margaret M. Spolar, Montrose, PA (US)

Correspondence Address: Mark Levy;HINMAN, HOWARD & KATTELL, LLP, 80 Exchange Street, P.O. Box 5250, BINGHAMTON, NY, 13901, US

(21) Appl. No.: 12/823,353

(22) Filed: Jun. 25, 2010

Related U.S. Application Data
(63) Continuation-in-part of application No. 12/156,974, filed on Jun. 6, 2008.
Application No. 12/156,974 is a continuation-in-part of application No. 11/985,393, filed on Nov. 15, 2007.
(60) Provisional application No. 60/872,860, filed on Dec. 5, 2006.
(60) Provisional application No. 61/065,521, filed on Feb. 13, 2008.

(51) Int. Cl. G06Q 30/00; G06Q 90/00

(52) U.S. Cl. 705/27.1; 705/26.1; 705/500

(57) ABSTRACT

A system for facilitating commerce by the use of an overseer network. The system includes processing steps that allow a customer to purchase goods or services by selecting a first retail establishment either from his home computer or from the location of a second retail establishment. If a third retail establishment or web site is a member of the overseer network, the customer may pay for the ordered goods or services from any one of the first, second, or third retail establishments and receive his goods or services from the first retail establishment.

### RELATED PATENT APPLICATIONS

The present patent application is a continuation-in-part of copending U.S. patent application Ser. No. 23/319,506, filed Jan. 7, 2009, Ser. No. 12/156.974, filed Jun. 6, 2008, which was a continuation-in-part of copending U.S. patent application Ser. No. 11/985,393, filed Nov. 15, 2007 for ENTERTAINMENT, BUSINESS TRANSACTIONS, INFORMATION, TELECOMMUNICATIONS INTERNET PACKAGE, which was a continuation-in-part of U.S. provisional patent application Ser. No. 60/872,860, filed Dec. 5, 2006, for ENTERTAINMENT, BUSINESS TRANSACTIONS, INFORMATION, TELECOMMUNICATIONS PACKAGE, and of copending U.S. provisional patent application Ser. No. 61/065,521, filed Feb. 13, 2008, all of which are hereby incorporated by reference.

### FIELD OF THE INVENTION

The invention pertains to methods and apparatus for facilitating commercial transactions and, in particular, for allowing a customer to purchase goods and/or services at a remote location using the Internet.

### BACKGROUND OF THE INVENTION

Commercial products or items and entertainment content are used every day. In fact, a high percentage of the consumer fee for entertainment content such as DVDs and CDs, whether used to hold music, movies, games, data or computer software for example, is for the purchase of these products. Likewise commercial products such as, but not limited to, food items, consumer electronics, electrical products, hardware, automotive and accessories therefor, textile items, toys, sporting goods, specialty items, specialty services, stationery, crafts, books, magazines, memorabilia of all sorts, footwear, health and beauty items, collectibles, home and garden, jewelry, linens, clothing, pottery, glassware, computers, and computer products, computer services, gift certificates, gift cards, cameras, art, antiques, and the like, phone cards, credit cards, debit cards, and entertainment products, are used on a daily basis and distributed in large quantities usually in a reliable, inexpensive package.

Many products, services, and information can be purchased at retail stores or accessed for purchase via the Internet. The consumer searches the best way to shop. Whether the consumer shops using retail or Internet, he is usually in search of an easier way in which to complete purchases.

There are many types of cashier computers, also known as system computers or computer checkout stations, to handle monetary transactions, including but not limited to point-of-sale (POS) systems, First Data, retail management systems, cash tellers, Microsoft Dynamics, Sharp, Casio, Palm Pilot, BarCode Scanners, IBM retailer, and Samsung. They all have similar functions: to compute exact change, simplify the cashier's role, involve the packing patron, track every thing, prepare audit data, and provide reports. A cashier computer is set up to minimize leakage and track every penny that is due. The cashier computer works the pricing, sales, and promotions. It handles inventory and payment processing. Point-of-sale (POS) systems replace standalone cash registers with computer-based sales software. A POS system may include a touchscreen, scanner, or keyboard for inputting prices, as well as a display and a computer. By helping track inventory, they reduce “shrinkage” and employee theft. Automatic price tracking improves price accuracy over traditional cash registers.

Nielsen's consumer packaged goods (CPG) research shows that shopping frequency across most retail supercenters, which enable consumers to combine shopping trips with more items in one store, continues to show growth. Alternative channels, including hardware/home improvement stores, office supply stores, automobile supply stores and bookstores are increasing the level of competition for traditional retailers and increasing the distribution opportunities for manufacturers.

Retail stores represent a friendly way for consumers to shop in a more personal way, in which the consumer can see and touch the product before he purchases it. The consumer can view the difference between other products and read labels more closely. The retail store develops a relationship with consumers, whereas the seller understands through its service what customers expect.

Retail purchases are made by way of cash, visa, ATM, debit, gift cards, and the like. Electronic data capture (EDC) magstripe-card swipe terminals have become ubiquitous, requesting the user to swipe his own card at the checkout station.

The Internet, as opposed to brick-and-mortar retail stores, has created a new set of connections between buyers and sellers and offers other possibilities for creating opportunities for businesses to deal with customers. Moreover, the Internet is a medium that can excite customer interest, can close sales quickly and conveniently, and can do so cost-effectively. It enables a customer to pay for goods or services by using credit cards.

Internet payment processing involves transactions over an open Internet connection, so the transaction can be performed online, potentially even on a web server itself. Internet transaction services typically provide an application programming interface (API), which is an HTML-type input terminal for manual entry and full online reports of transactions and batches thereof. Transaction processors are separate from the banks that provide a merchant account, although some providers provide a single transaction statement, seemingly providing a single service.

To avail himself of these services, a consumer must use a computer connected to the Internet, and be equipped with a web browser. The consumer must visit a web site to find the item that best services his needs. Once the consumer decides to make a purchase, the web pages show the consumer how to place an order and to pay for the product or service. The Internet Service Provider (ISP) receives those details across the Internet or, when purchasing at a retail store, at the counter.

Internet merchant accounts are separate bank accounts that are capable of receiving credit card payments from credit card providers. Internet merchant accounts typically do not hold funds for an extended period of time such a typical bank account, but usually transfer payments to another bank account designated by the Internet merchant on a daily basis.

The payment gateway account is the online credit card processor or transaction handler that is capable of hooking into credit card accounts belonging to the online consumer and the merchant's Internet merchant account. The payment gateway handles the verification and transfers requests. The term account when used with payment gateway is not the funds holding account but rather a service account that typically has a log in which configures the payment gateway settings.

Merchant services providers set up merchant accounts and a Gateway Credit. Merchant accounts are bank accounts specifically designed to accept and transfer credit card funds via the credit card processing network. Cards are processed through an Internet merchant account either manually through an in-store credit card terminal, online through a web based terminal page, or automatically through an associated payment gateway provider linking to the merchant's web shopping cart.

A third party payer merchant account alternative payment method such as PayPal can be used. In this payment method, Internet purchases are charged as if the third party payment service is the seller. Though the actual merchant sets up the store with products and pricing. The third party processor is technically the seller. The actual merchant then becomes a supplier and drop shipper.

Ecommerce or a gateway like USA Payment secures Internet payment processing. A merchant account, sometimes referred to as Internet/MoTo account, is needed. Merchant account companies act as a middleman between the merchant and the credit card provider and determines whether the applicant meets the provider's requirements.

The Internet is used to store data such as text, graphics, photo, audio or video files. The consumer may chose a product in physical form.

There are many ways to process and to hold information, such as computers, databases, systems, memory, Internet connections, hardware, and the like. Databases can contain information to allow tracking of items and transactions based on conditions, functions, attributes, labels, characters, and systems. One kind of database is that which is used as a structured collection of records or data which can be organized or categorized to structure, model, or support a model. Network models tend to store records with links to other records. The Internet can act as a model to store transaction data. An online database is a database accessible through the Internet and, as such differs from a local database held in an individual computer, system, or its attached storage, such as a CD or DVD.

A consumer would find it beneficial if he could go to an event (e.g., sports event, religious event, entertainment event, educational event, retail sales event, food event, a carnival, amusement parks, tours, etc.) or enter an establishment (e.g., a retail store, a club, a school, a college, a barber shop, a gas station, a restaurant, a church, a movie theater, and the like) and be able to pay for a product or service in advance of receiving it. Moreover, it would be advantageous for a customer to order a product or service online over the Internet, pay for such product or service at a location of his choice, and redeem such product or service at a predetermined convenient location.

### SUMMARY OF THE INVENTION

In accordance with the present invention, there is provided a system for facilitating commerce by the use of an overseer network. The system includes processing steps that allow a customer to purchase goods or services by selecting a first retail establishment either from his home computer or from the location of a second retail establishment. If a third retail establishment is a member of the overseer network, the customer may pay for the ordered goods or services from any one of the first, second, or third retail establishments and receive his goods or services from the first retail establishment.

### BRIEF DESCRIPTION OF THE DRAWINGS

A complete understanding of the present invention may be obtained by reference to the accompanying drawings, when considered in conjunction with the subsequent detailed description, in which:

FIG. 1a is a schematic view of a package in accordance with the invention, showing a telecommunication medium and an entertainment medium;

FIG. 1b is a schematic view of the reverse side of the package shown in FIG. 1a;

FIG. 2 is a flow chart of user operations in utilizing a telecommunications media (e.g., a telephone card);

FIG. 3 is a flow chart of manufacturer/distribution operations in acquiring and distributing entertainment content and telecommunications time;

FIG. 4 is a flow chart depicting user operations in participating in a contest relating to the inventive package;

FIG. 5 is a block diagram showing data flow from point of purchase to credit card and then to delivery;

FIG. 6 is a flow chart of user operations in utilizing a telecommunications media (e.g., a telephone card);

FIG. 7 is a flow chart of manufacturer/distribution operations in acquiring and distributing entertainment content and an item representative of monetary value;

FIG. 8 is a flow chart depicting user operations in participating in a contest relating to the inventive package;

FIG. 9 is a block diagram depicting Internet-based transaction of a consumer purchasing goods or services using a credit card;

FIG. 10 is a block diagram showing flow from point of purchase of a commercial item through the consumer and thence to the medium containing entertainment content;

FIG. 11 is a flow chart of manufacturer/distribution operations in acquiring and distributing entertainment content and selling the commercial item;

FIG. 12 is a flow chart of merchant operations for commercial items purchased over the Internet;

FIG. 13 is a flow chart depicting user operations in participating in a contest relating to the inventive entity;

FIGS. 14a and 14b, taken together, depict the front and obverse faces of a postcard used as a handout in accordance with the present invention;

FIG. 15 is a block diagram showing the system for allowing a customer to use bundles of similar or disparate goods and/or services;

FIG. 16 is a flow chart of manufacturer/distribution operations in acquiring and distributing entertainment content and selling bundles of commercial items;

FIG. 17 is a flow chart of user operations in purchasing goods or services at a retail establishment and redeeming them via the Internet or at a physical location;

FIG. 18 is a block diagram of one embodiment of the system in accordance with the invention, in which a customer may order goods or services from his home computer;

FIG. 18a is a flow chart of operations related to the block diagram of FIG. 18;

FIG. 19 is a block diagram of another embodiment of the system in accordance with the invention, in which a customer may order goods or services from the location of a retail establishment and pay for such goods or services from any retail establishment that is a member of the overseer network;

FIG. 19a is a flow chart of operations related to the block diagram of FIG. 19; and

FIG. 20 depicts the structure for generating a unique security code.

### DETAILED DESCRIPTION OF THE PREFERRED EMBODIMENT

The system enables commerce by the use of an overseer network. The system includes processing steps that allow a customer to purchase goods or services by selecting a first retail establishment either from his home computer or from the location of a second retail establishment. If a third retail establishment is a member of the overseer network, the customer may pay for the ordered goods or services from any one of the first, second, or third retail establishments and receive his goods or services from the first retail establishment.

The invention is a single entity for providing entertainment content with the purchase of a commercial product or monetary value item. A first medium holds the entertainment content, and the commercial item can be any product sold at a retail store or on the Internet. Commercial items or products may be, for example, foods, clothing, toys, health and beauty products, home and garden products, jewelry, linens, automotive, etc. Entertainment content is also storable on commercial products and may reside on such items as CDs, DVDs, games, electronic devices, downloadable files representative thereof, media that includes information representative of monetary funds, etc.

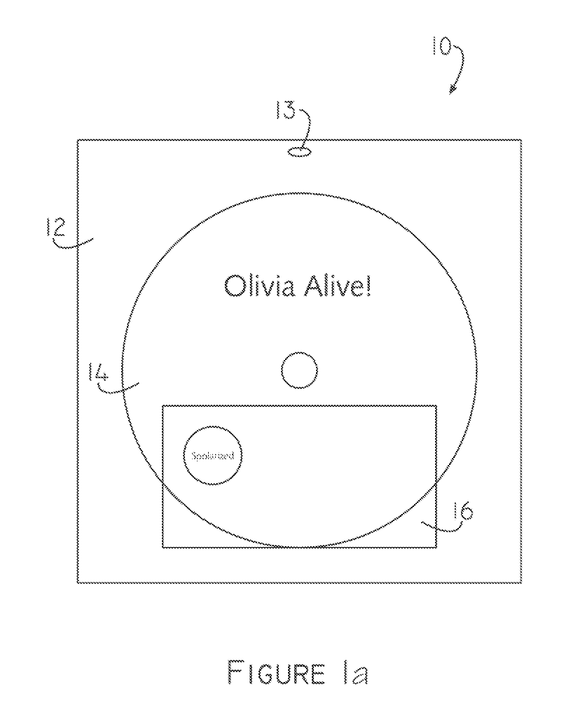

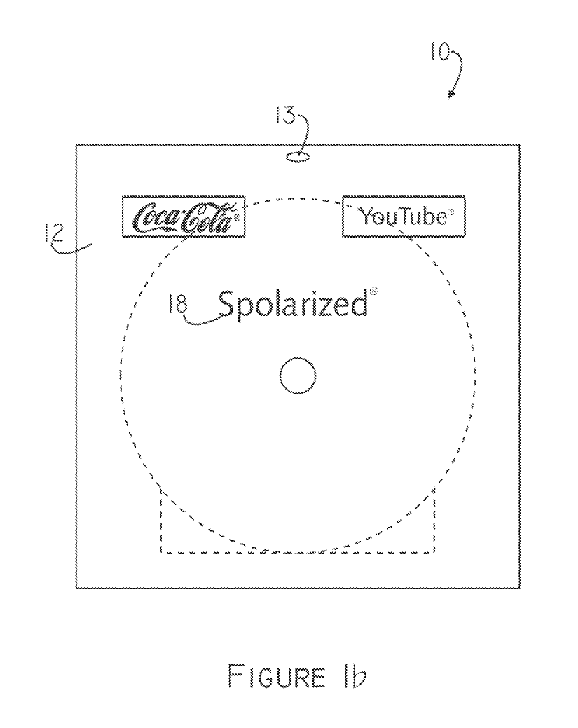

Referring now to FIGS. 1a and 1b, there is shown generally at reference number 10 a combination package or collection. A cardboard, laminated cardboard or plastic substrate 12 has an aperture 13 for hanging on a store display rack, not shown. Substrate 12 may be any suitable material for carrying out its function. Written material, such as the advertisement for a Spolarized® product, for example shown as reference number 18, can be printed on either or both front and rear sides of substrate 12. The written material may be used for advertising products of other manufacturers or vendors.

Entertainment media in the form of a CD, mini-CD or DVD 14 is attached and carried by the substrate 12. CDs and DVDs can be produced in any of a number of formats such as rewritable CD-R, DVD+R, high density, etc. It should be understood that other forms of the entertainment media such as, but not limited to entertainment cards (i.e., a card representative of monetary funds for entertainment content), can be provided, as desired, without departing from the scope of the invention. Since entertainment includes providing amusement (events, performances, recreational activities) to at least one person, other forms of the entertainment media include but are not limited to digital files residing on electronic devices such as memory sticks, non-volatile memory cards, MP3 players, optical storage disks, multimedia cards, solid state devices, (ROMs), handsets, Photo MP3, cellular telephones, computer games, Data Traveler, Digital MP3, satellite radio digital music, photos, prepaid plan cards, pay-as-you-go wireless, Internet service cards, laptop cards, mobile phone cards, landline telephones, cellular phones, Ticketmaster, band credit cards, debit cards, ATM cards, Internet service, gift card, membership card, rewards card, promotion card, celebrity card, ring tones, photo card, merchandise cards, entertainment cards, promotional cards, wireless gift card, YouTube, Kiosk, music downloads, movie downloads, parents cards, points cards, electronic video cards, mobile web and email, CB radio, walkie-talkie, digital cable, HBO Cinemax, DVR service, boost mobile, software, Broadband cards, Travel & Entertainment cards (T&E), house cards, air travel cards, calling cards, points cards, Internet-based applications, including Text messaging, PC card, USB modem, video share calling, micro SD, mini SD, Media players, MMS, QuickShare, messaging packing MSN, YAHOO, AOL, ICQ, AIM, Billboards, multimedia messaging, data download, upload burst, 2way SMA, dual band, Quad-Band(GPRS/EDGE) worldwide communication, instant messenger, social networks, Facebook, MySpace, Edge technology high speed data, Yahoo Messenger, and the like.

The separate distribution of each product typically has no advantage for the consumer. For years, music on CD, mini-CD, or DVD, books on DVD, movies on DVD, events on DVD, sports on DVD, exercise programs on DVD, stand up comedy on DVD, magicians on DVD, cooking on DVD, history on DVD, the Bible on DVD, educational programming on DVD, training programming on DVD, drivers training on DVD, gardening on DVD, health on DVD, dance on DVD, concerts on DVD, magic shows on DVD, yoga on DVD, computer games, Game Boy Advance, Nintendo DS, Nintendo GameCube, Nintendo Wii, Xbox, Play Station 2, Play Station 3, PSP, and the like have been sold separately.

A registration serial number, not shown, is embedded in the entertainment media 14 and optionally printed on substrate 12 and/or on a label therefore, Advertising can also be printed on media labels. The serial number is discussed in greater detail below. Moreover, printed material, such as advertising 18 (FIG. 1b) can be printed on entertainment media 14. Such printed material 18 can likewise be disposed on the face and/or obverse of entertainment media 14. Moreover, advertising in the form of sound and/or images can be embedded before, during or after the content stored on the entertainment media 14, itself, for play or display to the user.

Telecommunication media in the form of a plastic or other suitable physical card 16 is attached and carried by the substrate 12. It should be understood that other telecommunications media can be provided, as desired, without departing from the scope of the invention. In the preferred embodiment, plastic card 16 has a magnetic strip, not shown, attached to one surface thereof. The strip includes digital information representative of the number of telephone calling minutes purchased. In applying the magnetic strip, a suitable machine prints the card 16. The card 16 then is fed to a different machine that glues the strip not shown or a static bar to the card 16. The card 16 is then sent to a different machine that codes the bar. The magnetic strip is a thin layer of magnetizable material that is placed on conventional or rechargeable (PINGO) phone cards, iPhone cards, land line telephone cards, smart cards with embedded IC chip(s), credit cards, targeted credit cards (gas cards, store cards, student cards, parent cards, teen credit cards, etc.) bank ATM cards, debit cards, no-fee cards, gift cards, international phone cards, prepaid phone cards, pay as you go cards, money cards, travel cards, monetary fund cards, club cards, dinner cards, mobile phone memory cards, mobile prepaid plan cards, Internet service cards, and laptop cards, mobile phone cards, cellular phones, satellite radio, Ticketmaster, band credits cards, Internet service, membership cards, rewards cards, promotional cards, celebrity cards, ring tones, photo cards, merchandise cards, entertainment cards, music download, free loader, parents load, electronic video games, Kiosks cards, mobile tracker, cash and non-cash cards, walkie talkie, cardless calling cards, Internet-based applications, music player, and wireless gift cards.

The strip is a plastic material with magnetizable powder mixed in with it. The strip can be magnetized by exposing it to a strong magnetic field. Bits of the composition can be magnetized in different directions by a device that generates a strong magnetic field over a short distance. The strip can have many North and South poles on it. The numbers and locations of the poles are used to encode information.

The strip is read with a similar (or even the same) device that wrote it. The process also works in reverse. By moving the strip back and forth over a read head, voltages are induced in coils that can be amplified and recorded electronically, so that information can be sent to a computer. The PIN may activate through a mag strip, a bar code, etc., depending on which system and/or database terminal has been set up by the retail store to read PIN numbers. When the user purchases a phone card 16 at a register, the data are sent through the system that is in place with that retailer. The information is then sent to the carrier's central terminal to inform the carrier that the sale took place. The carrier then activates the PIN and sends a data wave to the partner.

As aforementioned, printed material such as advertising can be printed on either or both sides of substrate 12 on entertainment media 14, as well as on calling card/credit card, debit card, gift card, etc. 16.

Certain applications blur the distinction between entertainment and telecommunications, such as Blackberry service, WiFi, Yahoo, satellite radio (Sirius), San Disk memory cards, subscription services, broadband Internet service DMX digital music, iPhone, entertainment services and subscriptions, downloadable music, movies, games, and the like, phone service providers, cable networks, social networks, shared music, and Sansa Connect music players.

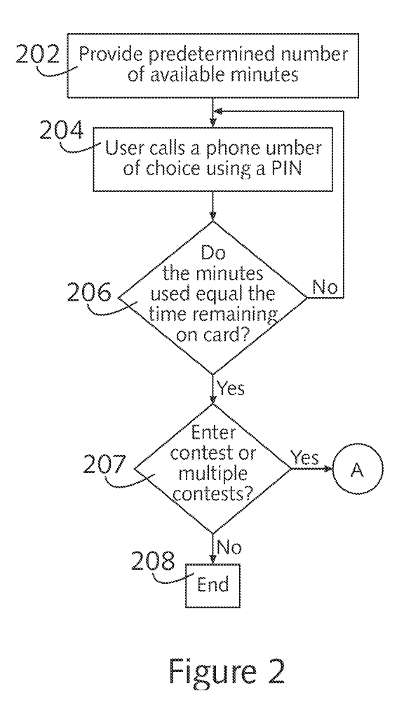

Referring now to FIG. 2, there is shown a flow chart of phone card operations. The card is provided with a predetermined number of minutes available, step 202.

A liaison company can be used to interact with retail stores and telecommunication companies. Such liaison companies typically receive a percentage of income for each minute purchased by the customer. In one embodiment of the invention, the telecommunications and entertainment company (TEC) also receives a percentage of income for each minute purchased by the consumer. A liaison is a point-of-service activation (POSA) and distribution partner for all major wireless carriers.

Phone cards are generally a prepaid method of making a long distance (domestic or international) call. Minutes means total time that can be used for one or more calls to one or more phone numbers (locations, area codes, countries). The cards can be used from any phone. Some prepaid phone cards can be refilled, usually by charging the additional cost to the user's credit card.

Prepaid phone cards represent telephone time a customer buys in advance. Users pay from $5 to $15, or more, up-front for local or long distance phone time. The amount of time bought depends on the rate-per-minute that is charged. The phone time is paid for in advance. Phone card companies keep track of how calling time is used by the PIN. Time can be added to some prepaid phone cards. The added cost can usually be billed to a credit card.

Pay as you go cards are prepaid mobile phone cards that are used with phones that the customer buys. Minutes are bought as needed. Prepaid cell phones allow the customer to pay for only the minutes needed.

For purposes of this disclosure, it should be understood that “telecommunications” includes but is not limited to landline telephones, cellular phones, satellite radio, MP3/DVD/CD/WMA receivers, wireless phones, Ticketmaster, Cable

Service, Instant messaging, Internet Service and Communication, Television Communication, Radio Communication, Satellite Communication, Email, etc. Giving due respect to the adage, “time is money,” telecommunications time, as used herein, is considered to have a monetary value, so that items that have such monetary value are expressly considered herein to include but not be limited to telephone cards and the like.

The user calls a phone number using a PIN, step 204. Most prepaid phone cards display a toll-free access telephone number and PIN. The PIN can be provided by any one or more of the following techniques: printed numbers, bar codes, magnetic strips, or optical character recognition (OCR) printed symbols. Alternatively, this activation step 204 can be accomplished without the use of a predetermined PIN number and even with the use of a phone number.

Prepaid phone card companies have computers that use the user's PIN to keep track of the card usage—how much time the user has on the card in minutes or units. To make a phone call, the user dials the access number, enters the PIN, and at the voice prompt, enters the phone number of the party the user is trying to reach. A computer informs the user of how much time—or how many units—the user has left on the card, and how to use other features the card may offer. Typically, each unit equals one minute for a domestic call. If the prepaid phone card cannot be recharged—that is, if the user cannot buy additional minutes by phone for the card—the user must buy another card once the time is used up.

Carriers are responsible for the telephone lines that carry calls. Resellers buy telephone minutes from carriers. Issuers set the rates and provide toll-free customer service and access numbers.

The number of minutes remaining on the card equals the original number of minutes paid for, less time used with the card, rounded up, step 206. Rounding is the billing increment unit. One Minute Rounding means that the billing increment is 1 minute. A call for 50 seconds, for example, is billed as 1 minute. Three Minute Rounding means that the billing increment unit is 3 minutes. A call for 7 minutes and 50 seconds is billed as 9 minutes. One plus three Minute Rounding means that for calls less than 1 minute, the user is charged for 1 minute. For calls more than 1 minute, the first minute is charged 1 minute and the following minutes are charged at 3 minute increments. A call for 2 minutes and 50 seconds is billed as 4 minutes.

The user decides whether to enter a TEC contest, step 207. For purposes of this disclosure, a “contest” is intended to include, but not be limited to, a prize, a sweepstake, a chance and consideration for the acquisition thereof. The user can decide to enter the contest by following the directions on the package 10 (FIG. 1a). There may also be multiple contests available on the package. The user may enter as many of the contests as are available. The contests include but are not limited to membership rewards, shopping cards, retailer's cards, Sirius radio, cable or Internet service, best CD album, best artists, best lyrics, best song, best movie, best actor, best soundtrack, best director, best producer, best book, best game, Ticketmaster, event tickets, and the like.

It should be understood that land line service can be purchased, and used in connection with the present invention, in which case a discount is available to encourage a user to maintain and retain his land line service. Minutes or cash payable to a user's bill can be claimed by a user who avails himself of the inventive product and services.

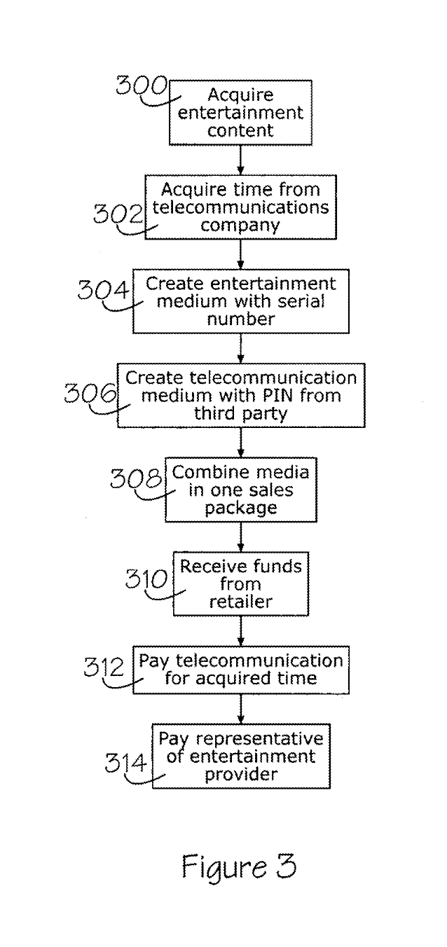

Referring now to FIG. 3, there is shown a flow chart of operations for acquiring and distributing entertainment content or combinations or bundles thereof and telecommunications options or combinations or bundles thereof. Entertainment content is acquired, step 300. The entertainment content may be movies on DVD, music on CD, music on mini-CD, books on DVD, stand up comedy on DVD, sports on DVD, events on DVD, exercise programming on DVD, music video on DVD, magician on DVD, history on DVD, the bible on DVD, dance on DVD, yoga on DVD, health on DVD, educational programs on DVD, gardening on DVD, magic shows on DVD, drivers training on DVD, cooking on DVD, stand up comedy on DVD, concerts on DVD, games, computer games on DVD, Game Boy, Nintendo DS, Nintendo GameCube, BlueRay, Nintendo WII, Play Station 2 and 3, PSP, entertainment cards that offer services, or gift cards for the purchase of certain entertainment products, and the like.

A license is acquired from the copyright holder for the use of music, movies, books, sports, events, games, exercise programming, computer games, and the like. The content is in the form of a CD/DVD, but is not limited thereto. For example, other forms of expression (e.g., written material) are contemplated herein.

Time is acquired from one or more telecommunications companies, step 302. The purchased time is encoded on a magnetic strip across the phone card 16 (FIG. 1a). The time can be activated when sold, although certain phone cards are prepaid.

An entertainment medium is created with a serial number, step 304, the serial number being placed on the entertainment medium itself.

A telecommunications medium is created with a PIN number, step 306. The PIN is placed on the telecommunications card and/or bank credit card, debt card, ATM card, iTune, eMusic card, Internet service medium, gift card, membership card, rewards card, entertainment card, Ticketmaster, promotional card, celebrity card, and the like, which may or may not match other serial numbers within the package.

A liaison such as InComm Interactive Voice Response (IVR) system can give customers easy-to-follow prompts to enter the pin and account numbers located on their card or receipt. This information is communicated to the payment database at the InComm Data Center, which verifies the information and transmits it to the appropriate carrier for activation.

Handset activation technology is activated at the register. InComm has a direct connection with the major carriers and can automatically activate the headset by the electronic serial number (ESN).

A liaison company can be used to interact with retail stores and telecommunication companies. Such liaison companies typically receive a percentage of income for each minute purchased by the customer. In one embodiment of the invention, the telecommunications and entertainment company (TEC) also receives a percentage of income for each minute purchased by the consumer. A liaison is a point-of-service activation (POSA) and distribution partner for all major wireless carriers.

The telecommunications and entertainment media are combined in one package, step 308. Accordingly, the telecommunication and entertainment package now contains a phone card, a DVD or CD with entertainment programming, and a rewards contest. It should be understood, however, that for purposes of this disclosure, the single event that includes telecommunications and entertainment media may, in fact, be purchased at different times, at different locations, and via different methods (e.g., physical sale, mail order, email order, Internet sale, etc.), yet still be considered a single package, entity or transaction.

Funds are received from one or more retailers, step 310. The retailer reports the sale or rental of the telecommunications and entertainment package on a monthly basis, preferably, but other periodic or non-periodic time frames can be negotiated. The retailer forwards the money from the sale or rental of the telecommunication and entertainment package on a monthly or quarterly basis, but shorter or longer payment periods can be negotiated. For purposes of this disclosure, the words “sale”, “sell” and “selling” are intended to include the concepts of renting and rented.

Telecommunications companies are paid for the acquired time, step 312, by the TEC. Minutes are paid as they are used or may be paid all at once for the telecommunications and entertainment package when purchased.

A representative of the entertainment provider is paid, step 314. The provider of the entertainment receives funds after the telecommunications and entertainment package has been purchased and the money has been received from the sale.

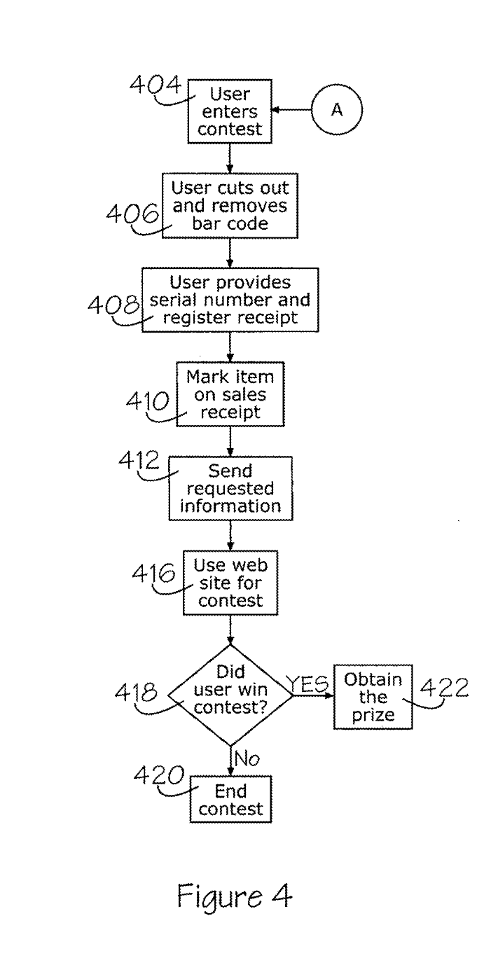

Referring now to FIG. 4, the user can enter a contest, step 404. By providing certain information along with a serial number, or multiple contest(s), the user mails or emails or calls in or otherwise conveys information requested from the telecommunications and entertainment package. In one embodiment, the user cuts out and removes the bar code on the telecommunications and entertainment package, step 406, and mails it with the required information.

The rules of the contest(s) require certain information and the serial number, or multiple serial numbers that pertain to the package, along with a register receipt, step 408. The serial number must be the correct number or multiple numbers that match the music, movies, games, books, sports, exercise programming, and the like. More than one person can win the contest and qualify for different prizes or the same prize. A purchaser who buys the entertainment package can also qualify to win multiple prizes merely by purchasing additional goods via a predetermined web site.

The user circles, highlights, clicks on or otherwise selects an item on his sale register receipt, step 410. The user circles the register receipt and mails or emails the bar code and the register receipt to the address on the telecommunications and entertainment package, step 412.

The web site is used to enter the contest or contests, step 416. The user can email certain information through the web site following the same process described hereinabove. If the user wins the contest, step 418, he can claim his prize, step 422.

The telecommunications and entertainment package holds one or more contests periodically to award a winner(s). The winner receives a prize selected by the telecommunications and entertainment company (TEC). The prize may be a car, a recreational vehicle, cash, stock, retail products, restaurant meals, a recording deal, travel, jewelry, clothing hotel reservations, special events, amusement parks fees, a movie deal, any other items or deals or combination thereof. The contest ends, step 420, when another customer wins a prize.

The user obtains the prize selected by the TEC at the time the company chooses. The date and location are chosen by the TEC, the terms of which may differ per contest. The method of shipment may be to pick up the prize at a certain designated location, by FedEx, UPS or regular mail service, or any other method of delivery that the telecommunications and entertainment company chooses. Any sales tax due on the prize will be paid for by the user in order to receive the prize by a certain date.

Advertisements may be printed or embossed on the outside packaging of package 10. The advertisement may also be included on the calling cards and/or the actual CD/DVDs themselves, or within the entertainment media so as to be displayed, performed or heard while listening to the CD/DVD or seen on a user's video display monitor.

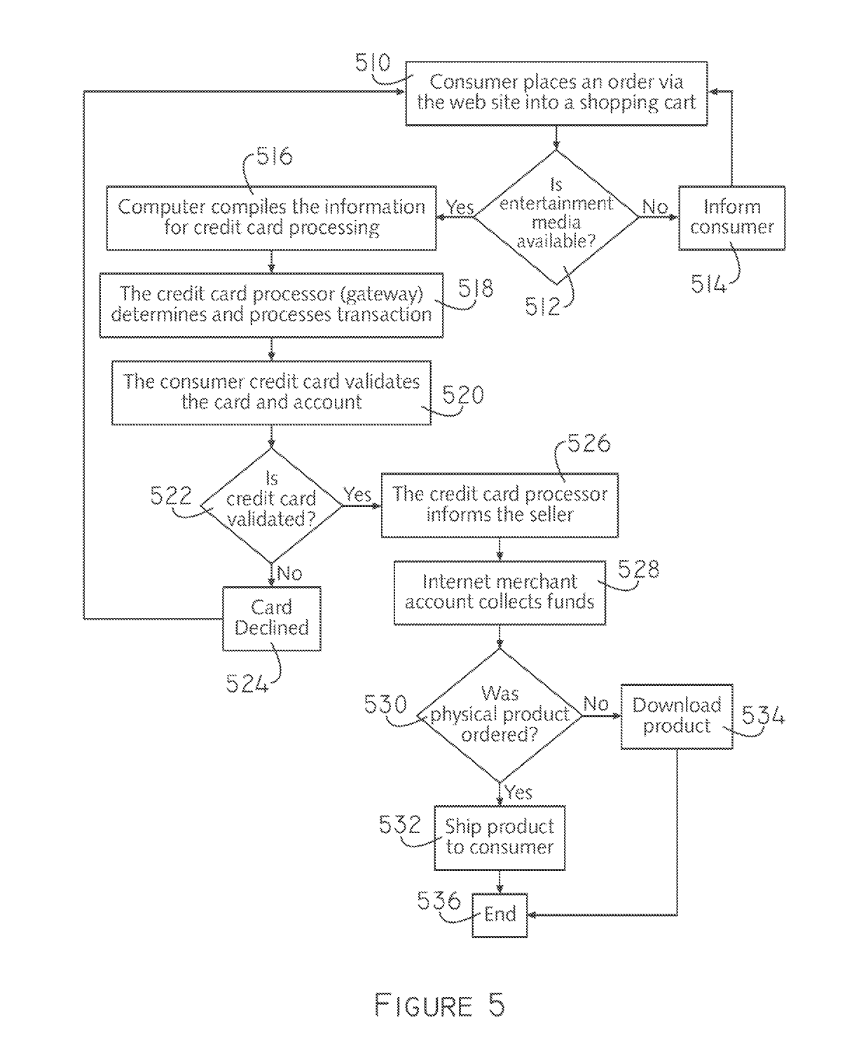

Referring now to FIG. 5, there is shown a flow chart of fulfillment operations in an Internet-based system. The consumer completes his order via a merchant's web store, step 510, specifying the number of minutes ordered and choice of entertainment. If the provider cannot fill the entertainment order, step 512, the customer is informed, step 514, and processing resumes from step 510.

The merchant's shopping cart program on the web host computer gathers the order information, step 516, compiling it into a suitable form for the credit card processing company.

The shopping cart transmits the formatted order from the web host to the credit card processor (payment gateway), step 518. The credit card processor checks the information received regarding the order to ensure all required information is sent to continue processing the transaction. The processor then determines what company manages the customer's credit card and transmits a request for the card to be charged, step 518.

The customer's credit card company validates the card and the account, step 520. If sufficient credit is not available, step 522, the system declines the card, step 524 and resumes processing at step 510. The credit card company also sends a code back to the credit card processor indicating the nature of the problem. If everything checks out correctly and the credit card is clear for purchases, the credit card company sends an acknowledgement back to the card processor that the amount requested can be transferred, step 520.

The credit card processor notifies the merchant's shopping cart program at the web host whether the transaction was successful, step 526. The shopping cart then can notify the customer if the order was complete and can send the order on to the merchant for delivery of the product or service. The credit card processor initiates a funds transfer (settlement request) to the merchant account company for deposit into the merchant's bank account that it has on record.

Internet merchant accounts collect the funds for a specified period of time, step 528, and make scheduled transfers to the merchant's regular bank account. The credit card processing transaction is complete.

The consumer chooses a method of delivery. The consumer may prefer to have a physical product shipped directly to him, step 530, in which case the physical product is shipped directly to the consumer, step 532. The consumer may prefer to download the product, step 534. The transaction is completed, step 536.

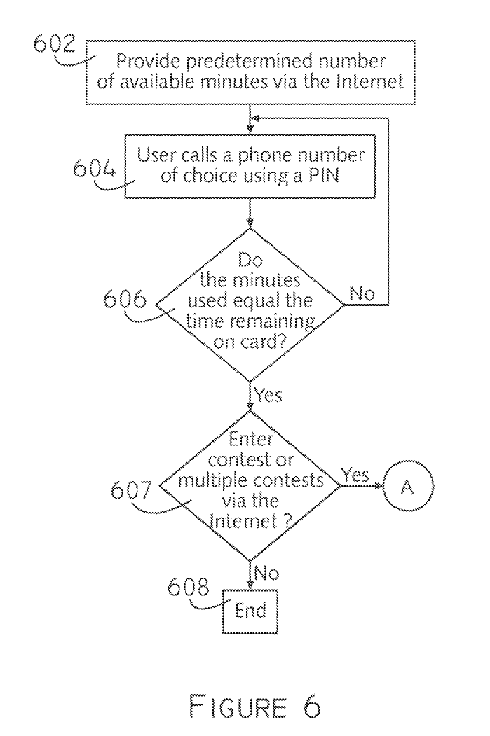

Referring now to FIG. 6, there is shown a flow chart of phone card operations. The card is provided with a predetermined number of minutes available, step 602.

A liaison company can be used to interact with retail stores and telecommunication companies. Such liaison companies typically receive a percentage of income for each minute purchased by the customer. In one embodiment of the invention, the telecommunications and entertainment company (TEC) also receives a percentage of income for each minute purchased by the consumer. A liaison is a point-of-service activation (POSA) and distribution partner for all major wireless carriers.

Phone cards are generally a prepaid method of making a long distance (domestic or international) call. Minutes means total time that can be used for one or more calls to one or more phone numbers (locations, area codes, countries). The cards can be used from any phone. Some prepaid phone cards can be refilled, usually by charging the additional cost to the user's credit card.

Prepaid phone cards represent telephone time a customer buys in advance. Users pay from $5 to $15, or more, up-front for local or long distance phone time. The amount of time bought depends on the rate-per-minute that is charged. The phone time is paid for in advance. Phone card companies keep track of how calling time is used by the PIN. Time can be added to some prepaid phone cards. The added cost can usually be billed to a credit card.

Pay as you go cards are prepaid mobile phone cards that are used with phones that the customer buys. Minutes are bought as needed. Prepaid cell phones allow the customer to pay for only the minutes needed.

For purposes of this disclosure, it should be understood that “telecommunications” includes but is not limited to landline telephones, cellular phones, Bluetooth, satellite radio, MP3/DVD/CD/WMA receiver iPod and XM-ready, Data Traveler, Sirus cable, cable service, instant messaging, Internet service and communication, other networks, television communication, radio communication, satellite communication, email, etc.

Land line service can be purchased, and used in connection with the present invention, in which case a discount is available to encourage a user to maintain and retain his land line service. Minutes or cash payable to a user's bill can be claimed by a user who avails himself of the inventive product and services.

The user calls a phone number using a PIN, step 204. Most prepaid phone cards display a toll-free access telephone number and PIN. The PIN can be provided by any one or more of the following techniques: printed numbers, bar codes, magnetic strips, or optical character recognition (OCR) printed symbols. Alternatively, this activation step 604 can be accomplished without the use of a predetermined PIN number and even with the use of a phone number.

Prepaid phone card companies have computers that use the user's PIN to keep track of the card usage—how much time the user has on the card in minutes or units. To make a phone call, the user dials the access number, enters the PIN, and at the voice prompt, enters the phone number of the party the user is trying to reach. A computer informs the user of how much time—or how many units—the user has left on the card, and how to use other features the card may offer. Typically, each unit equals one minute for a domestic call. If the prepaid phone card cannot be recharged—that is, if the user cannot buy additional minutes by phone for the card—the user must buy another card once the time is used up.

Carriers are responsible for the telephone lines that carry calls. Resellers buy telephone minutes from carriers. Issuers set the rates and provide toll-free customer service and access numbers.

If the number of minutes remaining on the card does not equal the original number of minutes paid for, step 606, the user can continue using his minutes on the call or can make another call. If, however, the number of paid minutes is used up, step 606, the system enters a contest phase, step 607, described hereinbelow. Rounding is employed for the billing increment unit. One Minute Rounding means that the billing increment is 1 minute. A call for 50 seconds, for example, is billed as 1 minute. Three Minute Rounding means that the billing increment unit is 3 minutes. A call for 7 minutes and 50 seconds is billed as 9 minutes. One plus three Minute Rounding means that for calls less than 1 minute, the user is charged for 1 minute. For calls more than 1 minute, the first minute is charged 1 minute and the following minutes are charged at 3 minute increments. A call for 2 minutes and 50 seconds is billed as 4 minutes.

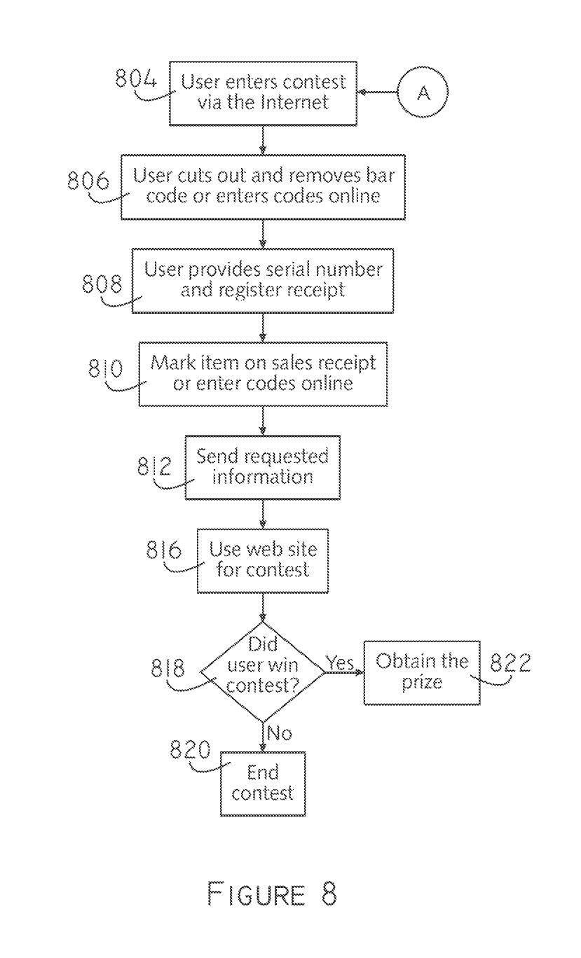

The user decides whether to enter a TEC contest, step 607. For purposes of this disclosure, a “contest” is intended to include, but not be limited to, a prize, a sweepstake, a chance and consideration for the acquisition thereof. The user can decide to enter the contest by following the directions on the package and/or online. There may also be multiple contests available on the package. The user may enter as many of the contests as are available. The contests include but are not limited to membership rewards, shopping cards, retailer's cards, Sirius radio, cable or Internet service, best CD album, best artists, best lyrics, best song, best movie, best actor, best soundtrack, best director, best producer, best book, best game, Ticketmaster, event tickets, and the like. If the user decides not to participate in a contest, step 607, processing determinates, step 608. Processing resumes at “A” which is shown in detail at FIG. 8.

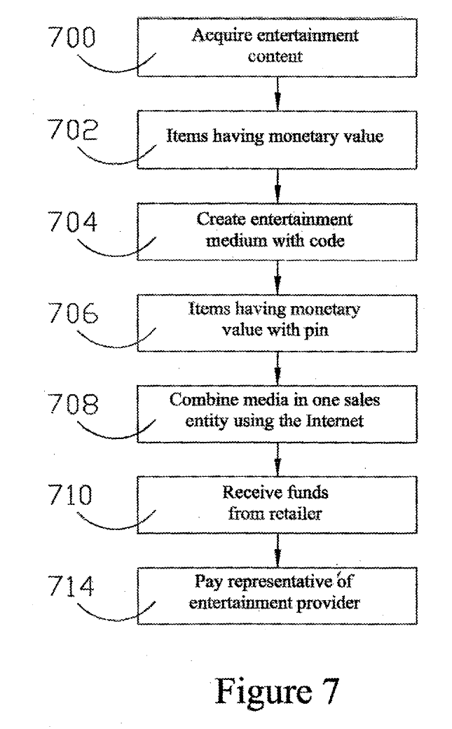

Referring now to FIG. 7, there is shown a flow chart of operations for acquiring and distributing entertainment content or combinations or bundles thereof, and items having monetary value or combinations or bundles thereof. Entertainment content is acquired, step 700. The entertainment content may be movies on DVD, music on CD, music on mini-CD, books on DVD, stand up comedy on DVD, sports on DVD, events on DVD, exercise programming on DVD, music video on DVD, magician on DVD, history on DVD, the Bible on DVD, dance on DVD, yoga on DVD, health on DVD, educational programs on DVD, gardening on DVD, magic shows on DVD, drivers training on DVD, cooking on DVD, stand up comedy on DVD, concerts on DVD, games, computer games on DVD, PSP, downloads, entertainment cards that offer services, or gift cards for the purchase of certain entertainment products, and the like. Such entertainment content may also include theater tickets, sport events tickets, movie tickets, concert tickets and the like.

A license is acquired from the copyright holder for the use of music, movies, books, sports, events, games, exercise programming, computer games, Internet services such as Napster, PSP, and the like. The content is in the form of a CD/DVD, but is not limited thereto. For example, other forms of expression (e.g., written material) are contemplated herein.

Items having monetary value, including but not limited to, credit cards, gift cards, debit cards, vouchers, coupons, subscriptions and services, step 702. The monetary value of the items can be activated when sold.

An entertainment medium can be created with a code, step 704, the code being placed on the entertainment medium itself.

An item having monetary value is created with a PIN number, step 706. The PIN is placed on the item having monetary value, such as a bank credit card, debit card, ATM card, Internet service medium, gift card, membership card, rewards card, entertainment card, Ticketmaster, promotional card, celebrity card, and the like, which may or may not match other codes within the package.

A liaison such as InComm Interactive Voice Response (IVR) can give customers easy-to-follow prompts to enter the PIN and account numbers located on their card or receipt. This information is communicated to the payment database at the InComm Data Center, which verifies the information and transmits it to the appropriate carrier for activation.

Handset activation technology is activated at the register. InComm has a direct connection with the major carriers and can automatically activate the headset by the electronic serial number (ESN).

A liaison company can be used to interact with retail stores and banking, brokerage, or retail establishments. A liaison is a point-of-service activation (POSA) and distribution partner.

The items having monetary value and the entertainment media are combined and/or bundled in one package, step 708. Accordingly, the items of monetary value and the entertainment package now contains a credit card or gift card, etc., a DVD or CD with entertainment programming, and a rewards contest.

Funds are received from one or more retailers, step 710. The retailer reports the sale or rental of the items having monetary value and entertainment package on a monthly basis, preferably, but other periodic or non-periodic time frames can be negotiated. The retailer forwards the money from the sale or rental of the items having monetary value and entertainment package on a monthly or quarterly basis, but shorter or longer payment periods can be negotiated. For purposes of this disclosure, the words “sale”, “sell” and “selling” are intended to include the concepts of renting and rented.

A representative of the entertainment provider is paid, step 714. The provider of the entertainment receives funds after the items of monetary value and entertainment package has been purchased and the money has been received from the sale.

Referring now to FIG. 8, as aforementioned, the user can enter a contest, step 804. By providing certain information along with a serial number, or multiple contest(s), the user mails or emails or calls in or otherwise conveys information requested from the telecommunications and entertainment package. In one embodiment, the user cuts out and removes the bar code on the telecommunications and entertainment package, step 806, and mails it with the required information.

The rules of the contest(s) require certain information and the serial number, or multiple serial numbers that pertain to the package, along with a register receipt, step 808. The serial number must be the correct number or multiple numbers that match the music, movies, games, books, sports, exercise programming, and the like. More than one person can win the contest and qualify for different prizes or the same prize. A purchaser who buys the entertainment package can also qualify to win multiple prizes merely by purchasing additional goods via a predetermined web site.

The user circles, highlights, clicks on or otherwise selects an item on his sale register receipt, step 810. The user circles the register receipt and mails or emails the bar code and the register receipt to the address on the telecommunications and entertainment package, step 812.

The web site is used to enter the contest or contests, step 816. The user can email certain information through the web site following the same process described hereinabove. If the user wins the contest, step 818, he can claim his prize, step 822; otherwise, processing terminates, step 820.

The telecommunications and entertainment package holds a contest periodically to award a winner. The winner receives a prize selected by the telecommunications and entertainment company. The prize may be a car, a recreational vehicle, cash, stock, retail products, restaurant meals, a recording deal, travel, jewelry, clothing hotel reservations, special events, amusement parks fees, a movie deal, any other items or deals or combination thereof. The contest ends, step 420, when another customer wins a prize.

The user obtains the prize selected by the TEC at the time the company chooses. The date and location are chosen by the TEC, the terms of which may differ per contest. The method of shipment may be to pick up the prize at a certain designated location, by FedEx, UPS or regular mail service, or any other method of delivery that the telecommunications and entertainment company chooses. Any sales tax due on the prize will be paid for by the user in order to receive the prize by a certain date.

Advertisements may be printed or embossed on the outside packaging of the package. The advertisement may also be included on the calling cards and/or the actual CD/DVDs themselves, or within the entertainment media so as to be displayed, performed or heard while listening to the CD/DVD or seen on a user's video display monitor.

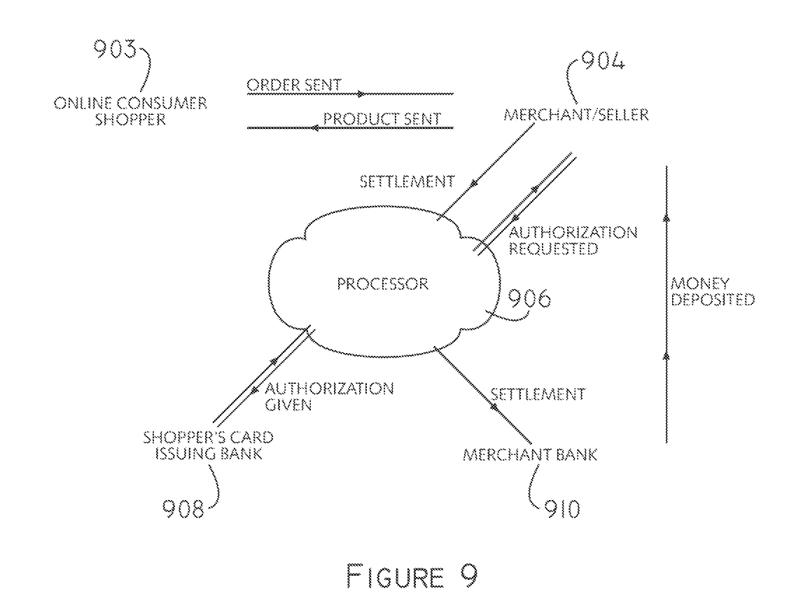

Referring now to FIG. 9, there is shown a flow chart of operations of point of purchase using a credit card. An online payment gateway account (the online card processor) and/or an Internet merchant account may be used. Though these are two separate components of credit card processing, they are usually necessary and work together to handle payments automatically. The consumer 903 makes a purchase, which is sent to the seller 904. The seller 904 sends the order to a processor 906 for authorization. The processor 906 sends the order onto the consumer's issuing bank 908 for authorization. The issuing bank 908 gives the authorization by sending the authorization back to the processor 906. The processor 906 sends the authorization onto the seller 904 that the product authorization has cleared and that the product ordered can be shipped. The seller 904 ships the product. The processor 906 sends the authorization settlement to the seller's bank 910 that a purchase has been made and has cleared. The seller's bank 910 deposits the money into the account of the seller 904.

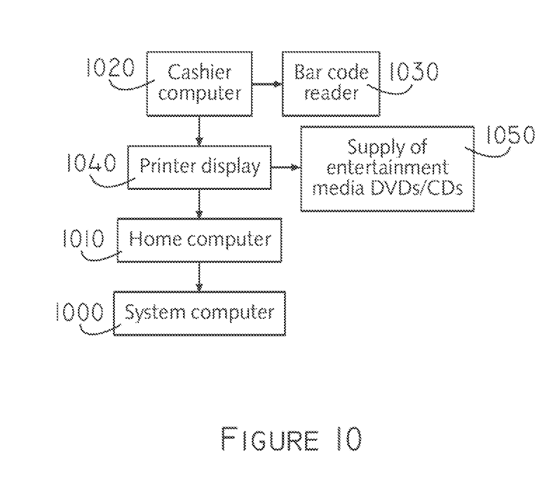

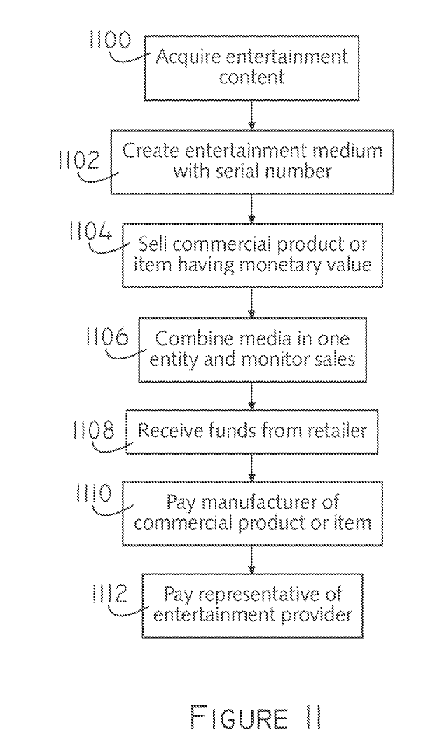

Referring now to FIG. 10, there is shown a block diagram showing flow from point of purchase of a commercial item through the consumer and thence to the medium containing entertainment content. A system computer 1000 is provided and accessible via an Internet connection. System computer 1000 includes at least one database, not shown, that contains information to allow tracking of items and transactions based on conditions, functions, attributes, labels, characters, and systems. The database(s) include information, operating systems, operations, fundamental features, limits, tables and views, indexes, other objects, external links, implementations, sources, logs, transactions, updates, documents, links to other stores, concurrency controls, query optimizers, and the like, to complete the sale of a commercial product and the providing of entertainment content. For purposes of this description, the system computer 1000 is intended to include one or more databases, as aforementioned, computers, memory, connections, hardware, providers, structures, platforms, applications, software, information systems, digital circuitry, read-only memory (ROM), embedded systems, open source hardware, design services, test delivery and logistics, network services, communications, integration, processing, and the like.

Connected to system computer 1000 via an Internet connection is a customer's home computer 1010, which may optionally be used in a method disclosed hereinbelow.

A cashier computer or checkout station 1020 is also provided at a retail store, not shown. Cashier computer 1020 is operatively connected to a device 1030 for entering information relative to a commercial item, not shown. Device 1030 may be a bar code scanner, as shown, or any equivalent device for entering such information including, but not limited to a keyboard or voice-operated I/O device, an infrared device, an optical, magnetic or SAW device.

A printer and/or display 1040 connected to the cashier computer 1020 provides information for the cashier to direct the customer to redeem his entertainment medium, such as a CD or DVD, coupon or rewards gift. Located either at the checkout station or at another part of the retail store is a supply 1050 of entertainment media.

A consumer may prefer the commercial item to be shipped directly to him or to be printable by him, via the Internet. The consumer first fills the appropriate order form and adds a shipping and handling fee. An email address is mandatory for online orders, and many times the PIN codes are sent by email. The consumer may also fill out the order form online and choose the preferred delivery method. After the consumer logs into his account, he can check his purchase history. The consumer is able to print a receipt. After a consumer logs onto his account and fills in the needed information regarding his transaction, he can print the PIN codes or card templates.

Both online “payment gateway account” (the online card processor) and an “Internet merchant account” is used. Though these are two separate components of credit card processing, they are both necessary and work together to handle payments automatically.

Referring now to FIG. 11, there is shown a flow chart of manufacturer/distribution operations in acquiring and distributing entertainment content and selling the commercial item. One of the first steps in practicing the inventive system is to acquire entertainment content, step 1100. The entertainment content may be movies on DVD, music on CD, music on mini-CD, books on DVD, stand up comedy on DVD, sports on DVD, events on DVD, exercise programming on DVD, music video on DVD, magician on DVD, history on DVD, the bible on DVD, dance on DVD, yoga on DVD, health on DVD, educational programs on DVD, gardening on DVD, magic shows on DVD, drivers training on DVD, cooking on DVD, stand up comedy on DVD, concerts on DVD, games, computer games on DVD, PSP, entertainment cards that offer services, or gift cards for the purchase of certain entertainment products, digital files residing on electronic devices such as memory sticks, non-volatile memory cards, MP3 players, optical storage disks, multimedia cards, solid state devices (ROMs), Bluetooth handsets, Blackberry devices, HP iPAQ, cellular telephones, Data Traveler, sport event tickets, theater tickets, Digital MP3 WMA, Micro SD, XM card, satellite radio digital music, mobile prepaid plan cards, pay-as-you-go wireless, Internet service cards, laptop cards, mobile phone cards, landline telephones, cellular phones, satellite radio, Ticketmaster, band credit cards, debit cards, ATM cards, Internet service, gift card, membership card, rewards card, promotion card, celebrity card, ring tones, photo card, merchandise cards, entertainment cards, Amp'd card, promotional cards, wireless gift card, YouTube, Kiosk, music downloads, movie downloads, parents cards, points cards, electronic video cards, Free Leader, GPhone, mobile caller, PDA's, CB radio, walkie-talkie, digital cable, HBO Cinemax, DVR service, boost mobile, software, Broadband cards, cash and non-cash rewards, Travel & Entertainment cards (T&E), house cards, Mobile TV, air travel cards, cash and non-cash rewards, points cards, satellite radio digital music, Internet-based applications, subscription services, Express cards, T-Mobile to Go, Text messaging, WAV/AAC/AACT music players, PC card, USB modem, video share calling, micro SD, mini SD, Media players, DMX digital music, Facebook, MySpace, social networks, subscriptions, Sansa Connect music players, MMS, QuickShare, messaging packing MSN, YAHOO, AOL, ICQ, AIM, Billboards, multimedia messaging, data download speed burst, upload burst, 2way SMA, dual band, Quad-Band (GPRS/EDGE), worldwide communication, instant messenger, Edge technology high speed data, Yahoo Messenger, and the like.

A license is acquired from the copyright holder for the use of music, movies, books, sports, events, games, exercise programming, computer games, services, PSP, and the like. The content generally resides in media in the form of a CD or DVD, but is not limited thereto. For example, other forms of expression (e.g., written material) are contemplated herein.

The entertainment medium is also created with a serial number, step 1102, the serial number, not shown, being placed on the entertainment medium itself and may be humanly readable, although the serial number may be embodied in a magnetic stripe, a bar code or any other machine-readable form.

A commercial item, not shown, is then sold at the retail store or via the Internet, step 1104. Commercial items or products include but are not limited to food items, automotive, accessories, consumer electronics, electronic devices, hardware, textile, toys, sporting goods, specialty items, specialty services, stationery, crafts, books, footwear, health and beauty items, collectibles, home and garden items, jewelry, linens, clothing, pottery, glassware, computers and computer products, service, gift certificates, cameras, art, antiques, CDs, DVDs or any other media for storing entertainment content, video games, iPod, MP3, Blackberry, PDA, entertainment card, Internet services, computer games, entertainment services, memory card, entertainment content, memorabilia, and the like.

Advertisements may be printed or embossed on the outside packaging of the commercial item as well as on the entertainment media themselves, or within the entertainment media so as to be displayed, performed or heard while listening to the CD/DVD or seen on a customer's video display monitor.

The commercial items themselves may also include a serial number associated with the system computer 1000 (FIG. 10) or the entertainment medium. The retail seller may choose to shelve both commercial item and entertainment medium associated therewith together or may choose to provide the entertainment medium at a location remote from the commercial item and/or from the checkout station 1020 (FIG. 10). For purposes of this description, the commercial item or product and the entertainment medium are considered a single entity, even if provided in separate packages. Similarly, the transaction regarding the purchase of the commercial item and the delivery of the entertainment medium is considered a single transaction, even if the portions thereof are separated by time and distance (e.g., when the customer consummates downloading of the entertainment content via the Internet and his home computer 1010 (FIG. 10)).

The system allows a customer to purchase a commercial product, step 1106, and be rewarded with free or discounted entertainment content such as reside on a DVD, CD, games, electronic devices, or downloads, which entertainment content may also be provided via a download operation by the customer at a later time and different place via the Internet and his home computer, PDA, Blackberry, telephone, iPod, or MP3 player. A ticket or voucher relating to theater performances, concerts, sports events, and the like, can also be received by the customer at the cash register once a purchase is made.

It should be understood that downloading in any type of file, streaming, formats, shared networks, subscription downloads that requires set fees or monthly fees, encoded formats, laser, writing data, or other electronic devices, including, but not limited to, downloading subscription services from providers is considered a form of downloading. Providers include AT&T, Verizon, cable networks, telephones, PDA and Blackberry services, Time Warner, and the like. There are at least two ways of downloading: formats or common ways of encoding transmission of audio or video, and other forms of entertainment media. Moreover, a customer can purchase a download, or multiple downloads, for example, at a participating retail establishment, and use the cash register receipt (proof of purchase) to input the code printed thereon into his computer, PDA, Blackberry, etc. to receive his ordered merchandise (e.g., downloads, products, etc.). This operation is also considered a single package.

The system computer 1000 may be programmed to limit the number or type of rewards (e.g., entertainment content and media) according to the number, type and cost of commercial items sold to a single customer or family or household, or the frequency of such sales and locations thereof. Thus, the mere purchase of an inexpensive item such as a box of tissues may or may not be sufficient to justify a free movie on DVD, or a free CD. Similarly, credit card use many reward a customer only upon reaching certain levels of spending above say, $500. Moreover, a customer who purchases a number of items, such as a pair of shoes, in one day could be restricted to only one reward.

The organization receives appropriate funds from the seller or retailer, step 1108. The seller also pays the manufacturer or distributor of the commercial item, step 1110, although such payment can be made at an earlier stage of the process, depending upon the agreement reached between manufacturer, distributor and seller. Similarly, the organization, seller or distributor pays a representative of the entertainment provider, step 1112, pursuant to the agreement reached between entertainment media manufacturer or distributor and seller.

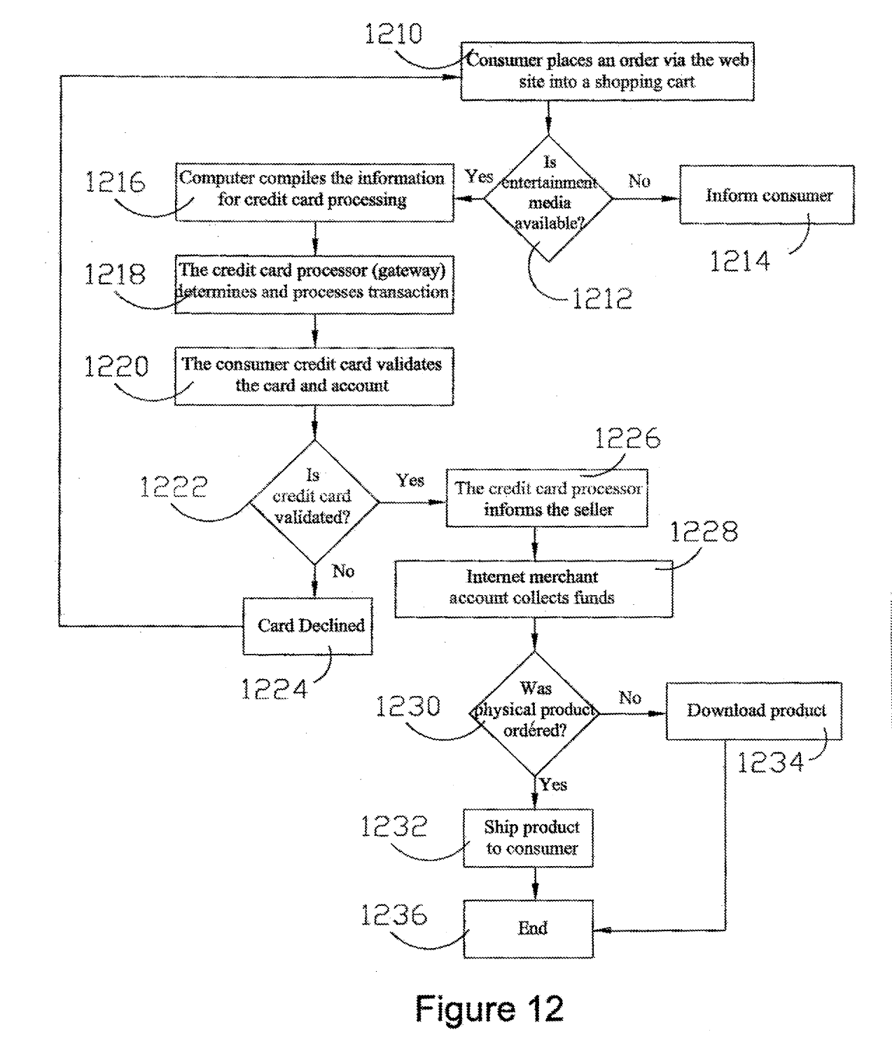

Referring now to FIG. 12, there is shown a flow chart of merchant operations for commercial items purchased over the Internet. The consumer completes his order via a merchant's web store, step 1210, specifying the item or product ordered and, optionally, choice of entertainment. If the provider cannot fill the entertainment order, step 1212, the customer is informed, step 1214, and processing resumes from step 1210.

The merchant's shopping cart program on the web host computer gathers the order information, step 1216, compiling it into a suitable form for the credit card processing company.

The shopping cart transmits the formatted order from the web host to the credit card processor (payment gateway), step 1218. The credit card processor checks the information received regarding the order to ensure all required information is sent to continue processing the transaction. The processor then determines what company manages the customer's credit card and transmits a request for the card to be charged, step 1218.

The customer's credit card company validates the card and the account, step 1220. If sufficient credit is not available, step 1222, the system declines the card, step 1224, and resumes processing at step 1210. The credit card company also sends a code back to the credit card processor indicating the nature of the problem. If everything checks out correctly and the credit card is clear for purchases, the credit card company sends an acknowledgement back to the card processor that the amount requested can be transferred, step 1220.

When the credit card is validated, step 1222, credit card processor notifies the merchant's shopping cart program at the web host whether the transaction was successful, step 1226. The shopping cart then can notify the customer if the order was complete and can send the order on to the merchant for delivery of the product or service. The credit card processor initiates a funds transfer (settlement request) to the merchant account company for deposit into the merchant's bank account that it has on record.

Internet merchant accounts collect the funds for a specified period of time, step 1228, and make scheduled transfers to the merchant's regular bank account. The credit card processing transaction is complete.

The consumer chooses a method of delivery. The consumer may prefer to have a physical product shipped directly to him, step 1230, in which case the physical product is shipped directly to the consumer, step 1232. The consumer may prefer to download the product, step 1234. The transaction is completed, step 1236.

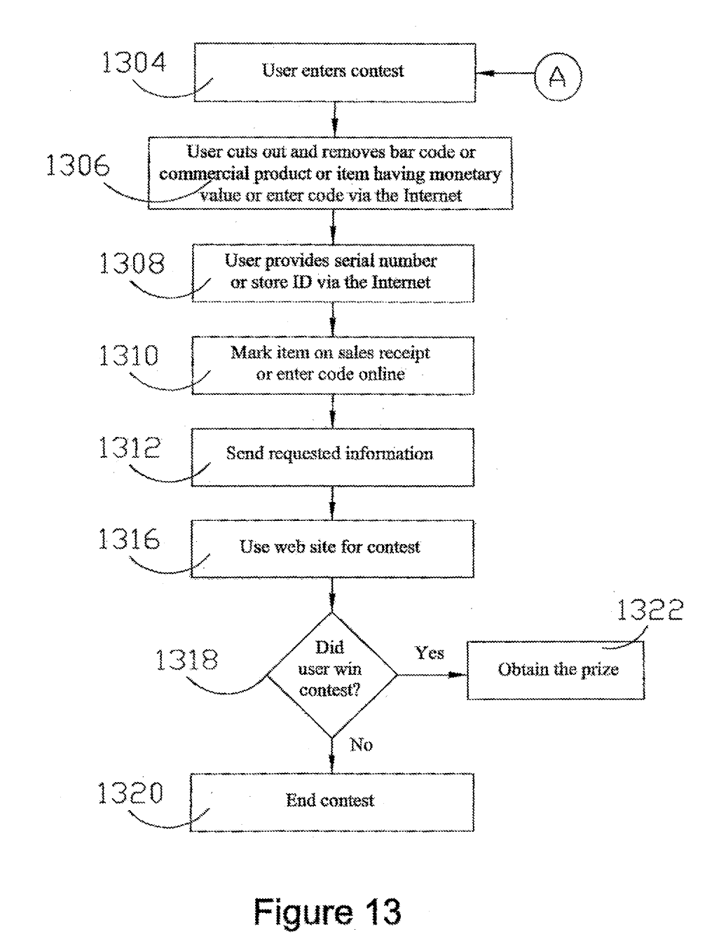

Referring now to FIG. 13, the customer can enter a contest, step 1304, which is held periodically to award a winner. The winner receives a prize selected by the inventive organization. The contests include but are not limited to a car, a recreational vehicle, cash, stock, retail products, restaurant meals, a recording deal, travel, jewelry, clothing hotel reservations, special events, amusement parks fees, a movie deal, membership rewards, shopping cards, retailer's cards, satellite radio, cable or Internet service, best CD album or DVD movie that include best artists, best lyrics, best song, best movie, best actor, best soundtrack, best director, best producer, best book, best game, Ticketmaster, event tickets, any other items or deals or combination thereof.

For purposes of this disclosure, a “contest” is intended to include, but not be limited to, a prize, a sweepstake, a chance and consideration for the acquisition thereof. The customer can decide to enter the contest by following the directions on the commercial item package, the entertainment medium, and/or online. There may also be multiple contests available on the commercial item package or entertainment medium. The customer may enter as many of the contests as are available.

By providing certain information along with a serial number, or multiple contest(s), the customer mails or emails or calls in or otherwise conveys information requested from the commercial item or entertainment medium. In one embodiment, the customer cuts out and removes the bar code on the commercial item package or entertainment medium, step 1306, and mails it with the required information.

The rules of the contest(s) require certain information and the serial number, or multiple serial numbers that pertain to the commercial item package and/or entertainment medium, along with a register receipt, step 408. The serial number must be the correct number or multiple numbers that match the music, movies, games, books, sports, exercise programming, and the like. More than one person can win the contest and qualify for different prizes or the same prize. A purchaser who buys the entertainment package can also qualify to win multiple prizes merely by purchasing additional goods via a predetermined web site.

The customer circles, highlights, clicks on or otherwise selects an item on his sale register receipt, step 1310. The customer circles the register receipt and mails or emails the barcode and the register receipt to the address on the commercial item and/or entertainment medium, step 1312.

The web site is used to enter the contest or contests, step 1316. The customer can email certain information through the web site following the same process described hereinabove. If the customer wins the contest, step 1318, he can claim his prize, step 1322; otherwise, processing terminates, step 1320. The contest ends, step 1320, when another customer wins a prize.

The customer obtains the prize selected by the inventive organization at the time the company chooses. The date and location, the terms of which may differ per contest, are chosen by the company. The method of shipment may be to pick up the prize at a certain designated location, by FedEx, UPS or regular mail service, or any other method of delivery that the telecommunications and entertainment company chooses. Any sales tax due on the prize will be paid for by the customer in order to receive the prize by a certain date.

The system allows the consumer to distinguish the method, model, application, channels in which the system uses to significantly reduce the operational cost for the consumer, as well as the seller. The system optimizes business transactions and automatically maximizes two products as one sale. The consumer may need to a computer, data, hardware, software, to comply with the requirements, via the Internet.

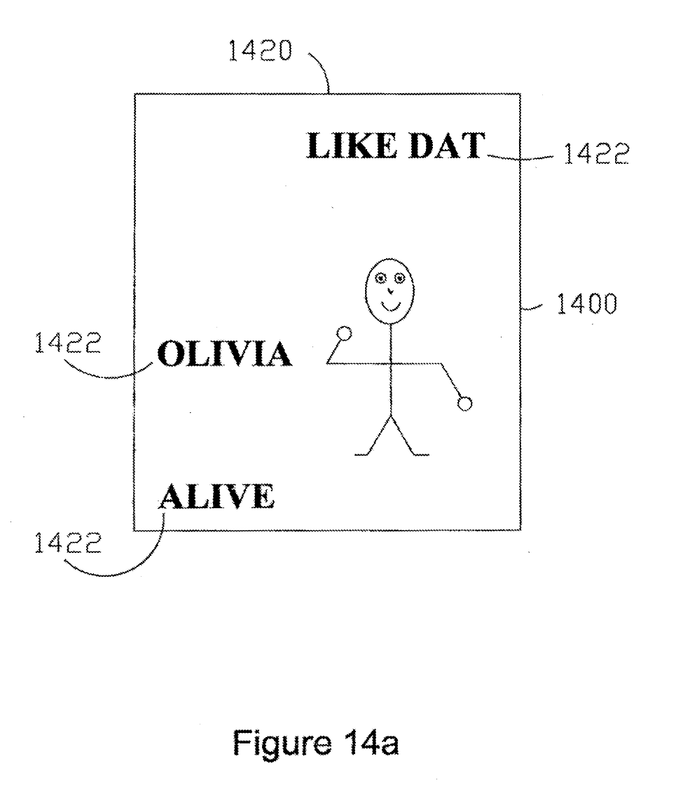

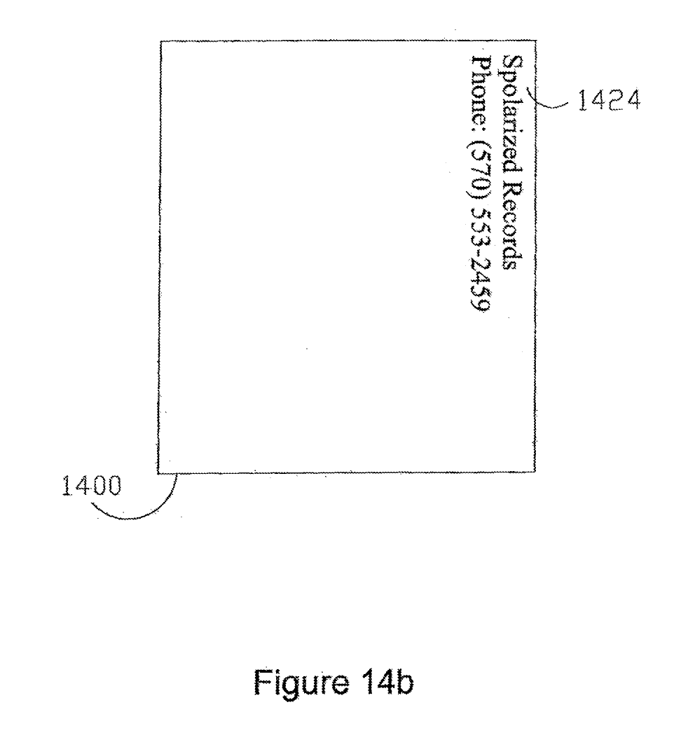

Referring now to FIGS. 14a and 14b, there is shown generally at reference number 1400 a postcard, a rectangular piece of thin paper or thin cardboard with decorative print of photographs, scenes, advertisement, and such, on one side or both, intended for writing, for advertisement, for mailing without an envelope or used as a handout. Written material, such as the advertisement for a Spolarized® product, for example shown as reference number 1422, can be printed on either or both front and rear sides of substrate 1420. The written material may be used for advertising products of other manufacturers or vendors.

The system is any type of advertisement, including but not limited to communication unpaid ads such as word-of-mouth, spread the buzz, tell a friend, a catch phrase, social networks.

A logo, trademark such as Spolarized®, content wrap, radio, television, commercials, telephone, Internet, organizations, public service announcements, register receipts, skywriting, shopping networks, coupons, Google, pop-ups, phone cards, streetcars, promotions, guerrilla, social networks, MySpace, Facebook, Second

Life, text messages, billboards, web banners, mobile phones and screens, seat back tray tables, shopping carts, streaming audio, downloads, motion pictures, ad trading, media buy or targeting, credit cards, gift cards, debit cards, ATM cards, phone cards, and the like; supermarkets, passenger screens, logo jets, in-flight advertisement, rack cards, Superbowl football, events, including but not limited to sport events, religious events, entertainment events, educational events, retail sales events, food events, carnivals, amusement parks, tours, music in advertising, infomercials, websites, message boards, content wraps, announcement centers, media, world wide web, spam, email, companies, international space station, corporate logos, announcements, printed public notices, broadcast pitch, satellite TV and radio, bandages, Internet devices such as TiVo and software, digital signing, BlueRay, public service announcements, cable networks, watches, cars, scarf, clothing, stickers on foods like apples, Band-Aids, diapers, mouse pads, overhead storage bins, VISA cards, ATM; and debit cards typically attempts to persuade potential customers to purchase or to consume more of a particular brand of products or services, or to potential customers make aware of such goods, services, and organization's events.

The advertisements used in this system are designed to generate increased consumption of those products and services, and events, through the creation and reinforcement of brand image and brand loyalty, or to sell tickets at venues. The advertisements can take many other forms like magazines, newspapers, coupons, bandages, printed material, postcards, register receipts, posters, calling cards, and the like. Many of the advertisements such as streetcars, billboards, tickets, seatbacks tray tables, wallpaper, international space station, companies, watches, clothing, cards, photos, commercial items, debit cards, visa cards, gift cards, buses, shopping carts, software, devices like TiVo, automotive, corporate logos, supermarkets, gas stations, shopping malls, the sides of buildings, banners, elastic bans on diapers, passenger screens, airlines in-flight ads, subway trains, announcement centers, content wraps, message boards, commercial items, and the like, can be placed in heavy traffic areas so the consumer can view the ads.

Advertisements can embed in the head a message. These types of advertisements are used as persuasive messages often with factual information. Every major medium is used to deliver these messages, including but not limited to television, radio, cinema, video, video games, the Internet, movies, music, social groups, organizations, political campaigns, interest groups, bus stops, public service announcements, non-profit groups, audio, visa cards, debit cards, gift cards, phone cards, public address systems, visual auto, printed rack cards and flyers, town criers, taxicabs, subway platforms and trains, street corners, gas stations, overhead storage bins, sidewalks, stickers on fruits, the opening section of streaming, audio and video, event tickets, advertising, supermarkets and chain stores, receipts at retailer stores, street furniture, trashcans, music stage shows, TV stage shows, promotions, telephones, websites, popups, phone screens, airports, stores, religious groups, military, announcement centers, BlueRay, message boards, content wraps, digital signing, spam, emails, sidewalks, sides of buildings, satellite TV and radio, worldwide web, MySpace, Facebook, Second Life, and the like, streaming audio, subliminal advertising, text messaging, social networks, web banners, cable TV, shop TV, MTV, VH1 and BET, other networks, product placement, infomercial, skywriting, online advertising, and the like, often placed by an advertising agency on behalf of a company, a club, or other organizations. The system helps the participating retailers, merchants, distributors, manufacturing companies and the like, learn what trends, styles, choices, clubs, organizations, Internet users want and expect from the participating parties along with their customers' likes and dislikes.

The system offers a more innovative involvement for the consumer, such as interactively choosing to text message, or various innovation social networking sites (e.g., MySpace, Facebook, Second Life) through the system the consumer can enjoy passing along a message.

A user may hear by word-of-mouth or a phrase such as, “sell it” or “tell a friend” or “spread the buzz” or a catch phrase like, “Spolarized® Energized”, indicating that a particular combination or a bundling package is available through a system. The user must than communicate to a participating supplier that he wants to use the system. Suppliers such as mass market chain stores, merchants, banks, gas stations, movie theaters, concerts, fairs, festivals, bowling alleys, art galleries, dances, retailers, casinos, attractions, farmer markets, live theaters, parks, racetracks, libraries, zoos, worship centers, WiFi hotspots, theme parks, museums, fund raisers, flea markets, merchant accounts, bingo centers, arenas and stadiums, clubs, events, political parties, Internet groups, military recruiters, churches, organizations, sport events, Internet, companies, groups, social networks, taverns, amusement centers, Google, Yahoo, Facebook, MySpace, Second Life, lodging places, restaurants, food courts, salons, barber shops, spa areas, pharmacies, networking centers, coffee shops, cruises, wineries, pubs, dinner theaters, comedy clubs, shopping malls, pet stores, body building clubs, automotive shops, specialty stores, sport bars, and the like, are participating suppliers able to activate promotional content and offer the specified combined or bundled package to a consumer.

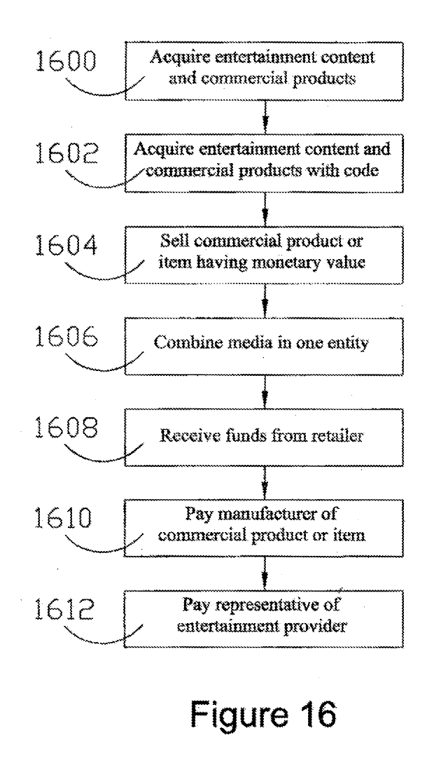

One or more content of specified items is set up within the system for a more cost-effective way for a customer to shop. More particularly, the user may want to use the system to its fullest extent by combining and/or bundling multiple specified items and also utilizing the contests. The system offers greater efficiency and instant gratification to the user when the user communicates by word-of-mouth, catch phrases, social networks, or by handing promotional products, such as postcards, flyers, stickers, calling cards, newspapers, magazines, gift cards, event tickets, movie tickets, announcement flyers, including but not limited to, or by way of the Internet, text messaging, cell phones, including but not limited, to a participating supplier indicating to them, that the user would like to use the system, of one or more content, combining and bundling, but not limited to such things as, a commercial product, entertainment item, information or business transaction, items having monetary value, as a single purchase. Combining and bundling is described in greater detail with reference to FIG. 16, below.

A registration serial number, not shown, is embedded in the advertisement 1422 and optional advertisement (word-of-mouth advertising) communication, media, radio and TV, and through language, can also be used to provide the serial number. The serial number is discussed in greater detail below. Moreover, advertising from multiple vendors on both sides of card 1400, can be printed.

The serial number identifies a system in which advertisement actives a combining and/or bundling of certain items. Moreover, the serial number can be activated through all forms of advertisement, embedded in sound and or images before, during or after the content is stored itself, for play or displayed to the user, including, but not limited to, word-of-mouth, communication, catch phrases, phones, phone cells, text messaging, television, radio, cable networks, screen savers, digital signing, music, Internet, games, popups, sky writing, walkie-talkie, phone cards, Google, Yahoo, networks, software, MSN, tickets, register receipts, sound, songs, movies, Facebook, MySpace, Second Life, social groups, websites, stickers on fruits, Band-Aids, overhead storage bins, clothing, cars, promotional material, CD/DVD's, announcements, message boards, satellite radio, land-line, and the like.

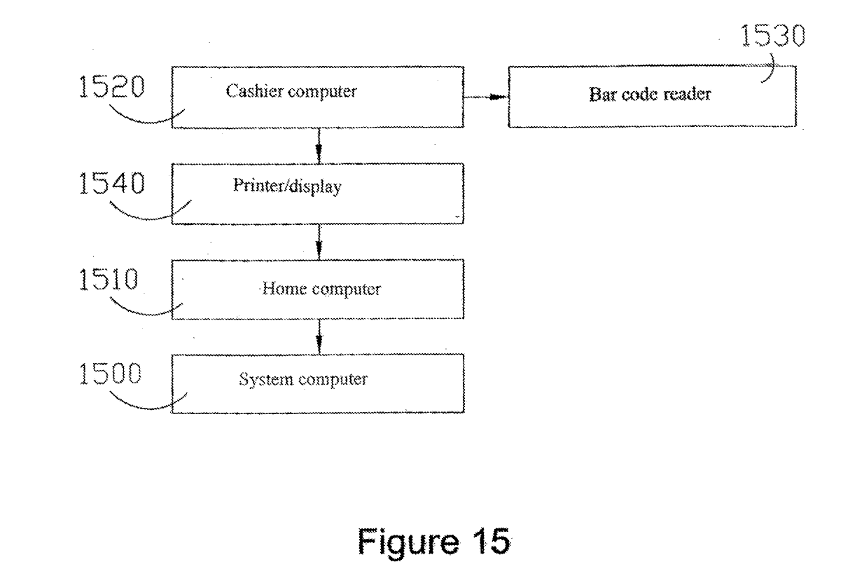

Referring now to FIG. 15, there is shown a block diagram of a system, wherein advertisement and promotional items activate a purchase which bundles one or more commercial products, items having monetary value, business transactions, and entertainment content. A system computer 1500 is provided and accessible via an Internet connection. The cashier computer 1500 computes exact change, simplifies the cashier's role, involves the packing patron, tracks everything, prepares audit data, and provides reports. Cashier computer 1500 is set up to minimize leakage and track every penny that is due. Cashier computer 1500 works the pricing, sales, and promotions. It handles inventory and payment processing.

System computer 1500 includes at least one database, not shown, that contains information to allow tracking of items and transactions based on conditions, functions, attributes, labels, characters, and systems. The database(s) include information, operating systems, operations, fundamental features, limits, tables and views, indexes, other objects, external links, implementations, sources, logs, transactions, updates, documents, links to other stores, concurrency controls, query optimizers, and the like, to complete the sale of an advertisement or promotional item with one or more commercial products, items having monetary value, business transactions, and entertainment content. For purposes of this description, the system computer 1500 is intended to include one or more databases, as aforementioned, as well as computers, memory, connections, hardware, providers, structures, platforms, applications, software, information systems, digital circuitry, read-only memory (ROM), embedded systems, open source hardware, design services, test delivery and logistics, network services, communications, integration, processing, and the like.

Connected to system computer 1500 via an Internet connection is a customer's home computer 1510, which may optionally be used in a method disclosed hereinbelow.

A cashier computer or checkout station 1520 is also provided at a retail store, not shown. Cashier computer 1520 can be any device capable of handling monetary transactions including, but not limited to, point-of-sale (POS) systems, Microsoft Dynamics, retail management systems, cash tellers, Casio PCR, Palm Pilot, barcode scanners, IBM, Royal, Samsung, and First Data systems. Cashier computer 1520 is operatively connected to a device 1530 for entering information relative to a commercial item, not shown. Device 1530 may be a bar code scanner, as shown, or any equivalent device for entering such information including, but not limited to, a keyboard or voice-operated I/O device, an infrared device, an optical, magnetic or SAW device.

A printer and/or display 1540 connected to the cashier computer 1520 provides information for the cashier to direct the customer to redeem his advertisement bundle medium, such as a commercial product, coupon or rewards gift.

A consumer may prefer the commercial item to be shipped directly to him or to be printable by him, via the Internet. The consumer first fills the appropriate order form and adds a shipping and handling fee. An email address is mandatory for online orders, and many times the PIN codes are sent by email. The consumer may also fill out the order form online and choose the preferred delivery method. After the consumer logs into his account, he can check his purchase history. The consumer is able to print a receipt. After a consumer logs onto his account and fills in the needed information regarding his transaction, he can print the PIN codes or card templates.

Consumers are more likely to buy items that offer something, that are discounted, have a coupon, or perhaps have a rewards program. A consumer likes to feel that he is receiving a saving of some sort. A consumer also likes to save time. Therefore, combining commercial products, entertainment items, information and business transactions, and/or things having monetary value benefit the consumer as well as the advertiser. The system represents a more efficient way for the advertiser to make sure the consumer pays attention to the ads and reads its advertisement.

In order for the user to use the system and activate the advertisement material and purchase the combined or bundled package, the user must visit the physical location of one of the participating suppliers, retailers, vendors, merchants, tellers, sponsor, restaurants, churches, schools, colleges, clubs, events, organizations, and the like, that are set up within the system.

In the inventive combined system a participating retailer, merchant, distributor, and/or a manufacturing company, organization, school, college, club, church, gas station, mass market chain store, fitness center, event, movie theater, concerts, bowling alleys, and the like, sets up one or more combined commercial products, entertainment items, information and business transactions, or items having monetary value, that is purchased as one sale. For example a combine package would consist of a promotional material, or word-of-mouth, or through communication, a flyer, a postcard, a billboard ad, a radio ad, a TV advertisement, a text message, a catch phrases, a public school or college announcement, an event flyer, mobile phone ads, and the like, in which the participating party has set up to become a participating partner with their promotional material or by word-of-mouth.

The combined package along with the promotional advertisement may consist of but not be limited to a download of a movie, a song, a Bluetooth, a game, a ticket to the movies, a ticket to a concert, a gift card, a jar of applesauce, a gallon of milk, a sport event, a dinner at the McDonald's restaurant, perhaps information or business transaction, or uses of a visa, a phone card, and the like, one or more items, in any combination. Moreover, the combined package may offer the combination including but not limited to, making a transaction in a bank, in a certain restaurant, in a drug store, in a grocery store, or at an ATM machine, purchase a gallon of milk, or purchase a jar of peanut butter, or purchase a can of coffee, or purchase of a gallon of wine, or purchase toothpaste, and may also ask the user to purchase one or more items such as a download of a movie, a purchase of a song, a toothbrush, an apple, or an orange, a in any combination, of commercial products, entertainment items, information and business transactions, or items having monetary value, as a combined package purchase.

In the inventive bundled package system a participating retailer, merchant, distributor, and/or a manufacturing company, organization, school, college, club, church, gas station, mass market chain store, fitness center, event, movie theater, concerts, bowling alleys, and the like, sets up one or more combined commercial products, entertainment items, information and business transactions, or items having monetary value, which are purchased as one sale. For example a bundled package consist of one or more promotional materials, or word-of-mouth, or through communication, a flyer, a postcard, a billboard ad, a radio ad, a TV advertisement, a text message, a catch phrases, a public school or college announcement, an event flyer, mobile phone ads, and the like, in which the participating party has set up to become a participating partner with their promotional material or by word-of-mouth.

The bundled package along with the promotional advertisement may consist of but not be limited to, multiple items such as a download of a movie or movies, a song or songs, a game or games, tickets to the movies, tickets to concerts, a gift card, two jars of applesauce, two gallons of milk, sport events, two dinners at the McDonald's restaurant on two different nights, perhaps information or business transaction, or uses of a visa, buy a phone card, and the like, one or more items, in any combination. Moreover, the bundle package may offer any combination but not limited to, making a transaction in a bank, in a certain restaurant, in a drug store, in a grocery store, or at an ATM machine, purchase a gallon of a milk, jar of peanut butter, or purchase a can of coffee, or purchase of a gallon of wine, or purchase toothpaste, and may also ask the user to purchase one or more items such as, a download of a movie, a purchase of a song, a toothbrush, an apple, or an orange, a in any combination, of commercial products, entertainment items, information and business transactions, or items having monetary value, as a bundle package purchase.

Referring now to FIG. 16, there is shown a flow chart of manufacturer/distribution operations in acquiring and distributing entertainment content and selling at least one commercial product. It should be understood that commercial products may be intangible, such as services, business transactions, and entertainment items and can be combined or bundled as described hereinbelow.

Other forms of the entertainment media such as, but not limited to, entertainment cards (i.e., a card representative of monetary funds for entertainment content), can be provided, as desired, without departing from the scope of the invention. Since entertainment includes providing amusement (events, performances, recreational activities) to at least one person, other forms of the entertainment media include, but are not limited to, digital files residing on electronic devices such as memory sticks, non-volatile memory cards, MP3 players, optical storage disks, multimedia cards, SanDisk, solid state devices (ROMs), Bluetooth handsets, Blackberry devices, cellular telephones, computer games, PSP, U3 Data Traveler, theater tickets, sport event tickets, MP3 FM tuner, Micro SD, satellite radio digital music, mobile prepaid plan cards, pay-as-you-go wireless, Internet service cards, laptop cards, mobile phone cards, landline telephones, cellular phones, Bluetooth, camera phones, satellite radio, MP3/DVD/CD/WMA receiver, Ticketmaster, band credit cards, debit cards, ATM cards, Internet service, gift card, membership card, rewards card, promotion card, celebrity card, ring tones, photo card, merchandise cards, entertainment cards, promotional cards, wireless gift card, YouTube, Kiosk, music downloads, movie downloads, parents cards, points cards, electronic video cards, Free Leader, GPhone, mobile caller, social networks, Facebook, MySpace, itune7, PDA's, Trac-Fone, WIFI, BlueRay, mobile web and email, CB radio, walkie-talkie, digital cable, HBO Cinemax, DVR service, boost mobile, software, Broadband cards, cash and non-cash rewards, Travel & Entertainment cards (T&E), house cards, Mobile TV, air travel cards, Photo MP3, Corel Snapfire, cash and non-cash rewards, points cards, satellite, Internet-based applications, including and WIFI laptop PC, Express cards, Text messaging, Java Games, WAV/AAC/AACT music players, walkman, PC card, USB modem, video share calling, micro SD, mini SD, Media players, MMS, QuickShare, messaging packing MSN, YAHOO, AOL, ICQ, AIM, Billboards, multimedia messaging, data download speed burst, upload burst, 2way SMA, dual band, Quad-Band(GPRS/EDGE) worldwide communication, BlueRay, instant messenger, social networks, Edge technology high speed data, Yahoo Messenger, and the like.

One of the first steps in practicing the inventive system is to acquire entertainment content and commercial products, step 1600. The commercial product may include, but not be limited to, bread, milk, eggs, toothpaste, hair spray, apples, clothing, gift cards, VISA cards, debit cards, ATM, phone cards, shoes, socks, cars, automotive, bikes, furniture, jewelry, and the like. Content for business transactions may include but not be limited to, using a VISA card, ATM, debit cards, phone cards, gift cards, and the like. Content of monetary funds may be, but not be limited to tickets, events, gifts, transactions, and the like. Content of entertainment may include, but not be limited to, CD/DVD movies, games, software, programs, phones, Internet, music players, electronic devices, and the like.

The entertainment medium is also associated with a code, step 1602, the code being placed on the items having monetary value, a business transaction, and/or entertainment medium itself and may be humanly readable, although the code may be embodied in a magnetic stripe, a bar code or any other machine-readable form. Of course, if the medium for disseminating the code is not tangible (e.g., only by word-of-mouth), such code is not placed on the items or business transactions. It should be understood that the term code includes, but is not limited to, codes, passwords, keywords, slogans, serial numbers, and phrases.

A commercial item is then sold at the retail store or via the Internet, step 1604. Commercial items include business transactions, services, and products that include but are not limited to food items, automotive, accessories, bread, milk, toilet paper, gift cards, VISA cards, debit cards, phone cards, consumer electronics, electronic devices, hardware, textile, toys, sporting goods, specialty items, specialty services, stationery, crafts, books, footwear, health and beauty items, collectibles, home and garden items, jewelry, linens, clothing, pottery, glassware, computers and computer products, service, gift certificates, cameras, art, antiques, CDs, DVDs or any other media for storing entertainment content, video games, MP3, Blackberry, PDA, entertainment card, computer games, entertainment services, memory card, entertainment content, memorabilia, and the like.

A license is acquired from the copyright holder for the use of music, movies, books, sports, events, games, exercise programming, computer games, PSP, and the like. The content generally resides in media in the form of a CD or DVD, but is not limited thereto. For example, other forms of expression (e.g., written material) are contemplated herein. A license may or may not be acquired for commercial products.

The system allows a customer to purchase a commercial product and be rewarded with free or discounted entertainment content such as reside on a DVD, CD, game, electronic device, download, step 1606, which entertainment content may also be provided via a download operation by the customer at a later time and different place via the Internet and his home computer, PDA, Blackberry, telephone, iPod, or other electronic device.

The organization receives appropriate funds from the seller or retailer, step 1608. The seller also pays the manufacturer or distributor of the commercial item, step 1610, although such payment can be made at an earlier stage of the process, depending upon the agreement reached between manufacturer, distributor and seller. Similarly, the organization, seller or distributor pays a representative of the entertainment provider, step 1612, pursuant to the agreement reached between the entertainment media manufacturer or distributor and seller.

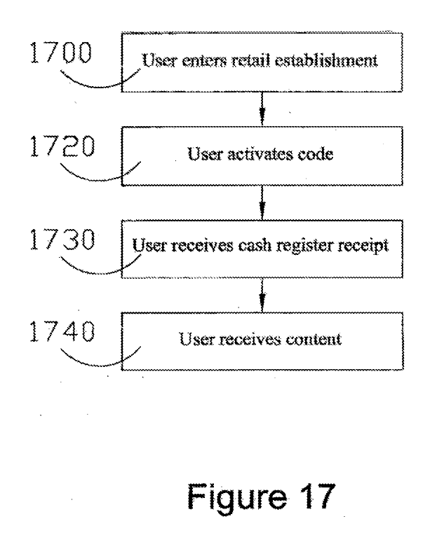

Referring to FIG. 17, the customer enters a participating, physical or Internet, retail establishment, and pays for his product(s), step 1700. The customer then can use his register receipt, if he has obtained one, to identify and activate his code, step 1720, for proffering to a participating retail establishment or Internet establishment at a later time.

A customer can purchase one or more downloads, theater tickets, sport event tickets, concert tickets, commercial products, entertainment items, business transactions, items of monetary value and information, and the like, by activating advertisement (code), step 1720. Once the customer makes a purchase at the register, he then may use the cash register receipt (proof of purchase), step 1730, to input the code printed thereon into his computer, PDA, Blackberry, etc. to receive his ordered merchandise (e.g., downloads, products, etc.), or receive physical products at the retail establishment itself, step 1740. In other words, physical products (e.g., theater tickets, sport event tickets, concert tickets, commercial products, entertainment items, business transactions, or items of monetary value and information) may be available at the participating retail establishment. The activating advertisement code completes the transaction of the combined and bundled system. This multi-step operation is also considered a single package.

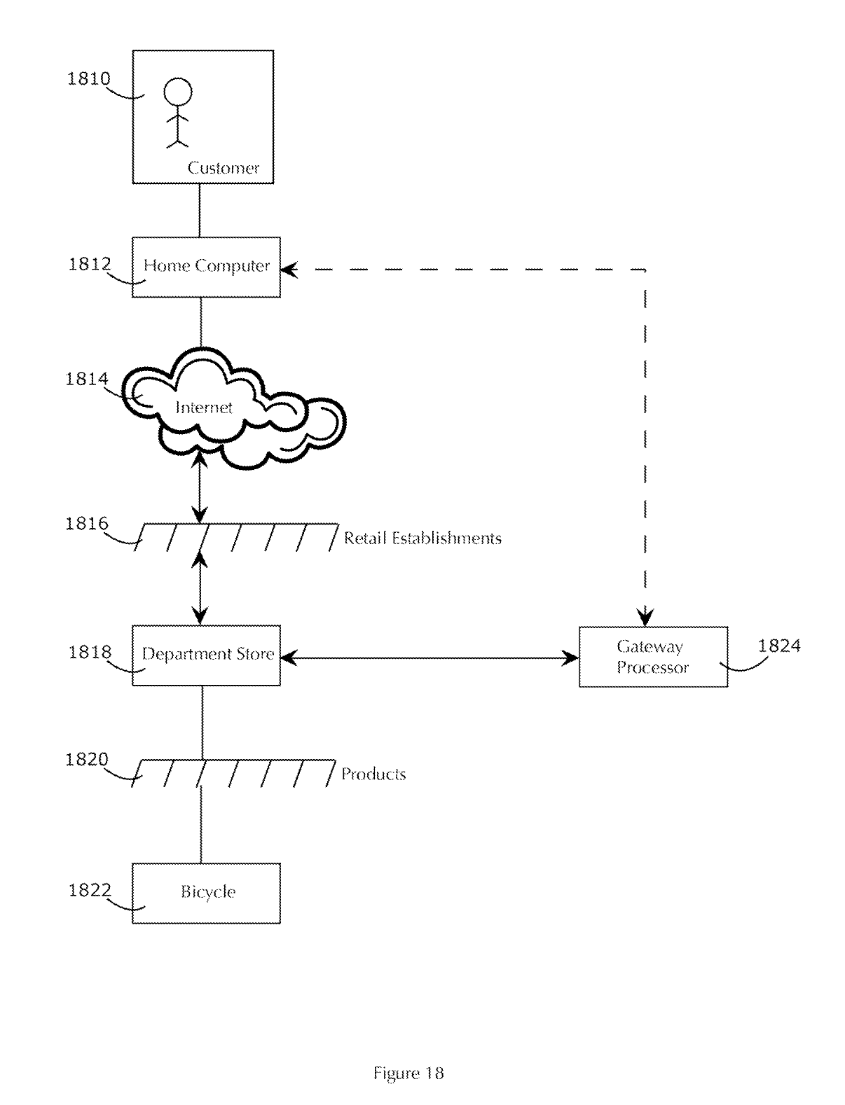

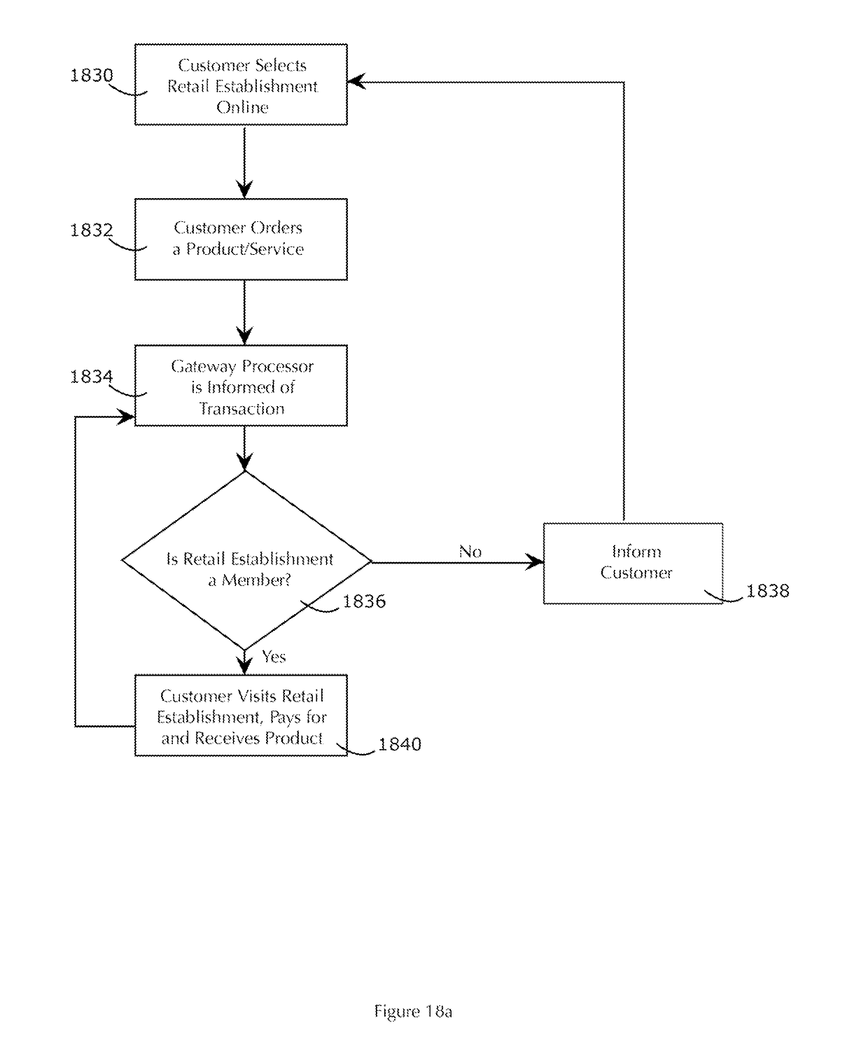

Referring now to FIG. 18, there is shown a block diagram for describing one embodiment of the invention in which a customer may purchase goods or services. A customer 1810 can use his home computer 1812 to access the Internet, cell phone, or PDA 1814. Any computer can be used for this operation as long as it can access the Internet. Certain customers may find it more convenient to access the Internet by means of such computer located some distance from their home. One of any number of businesses or retail establishments 1816 of interest to customer 1810 is accessible by the Internet 1814, by virtue of its connection via cyberspace thereto.

An overseer network is provided to allow predetermined customers to communicate with predetermined retail establishments with their associated POS terminal(s) and predetermined gateway. The overseer network is intended to assist the retail establishments to communicate transactions of customers to the gateway. The network also facilitates a security system for such transactions. In the example described herein, a department store 1818 is shown connected to the list of businesses 1816 connected to the Internet 1814. Each retail establishment 1818 includes a listing of its products or services 1820. For purposes of this example, one of the products 1820 is a bicycle 1822. Presumably, customer 1810 desires to purchase bicycle 1822 from department store 1818 via the Internet 1814.

A gateway, such as provided by Blackhawk or First Data, for example, and/or a processor 1824 is connected to the home computer 1812 and point of sale (POS) machine(s) in department store 1818.

Referring now also to FIG. 18a, there is shown a flow chart of operations relating to the block diagram of FIG. 18. Customer 1810 (FIG. 18) first selects a retail establishment online, step 1830. Customer 1810 then orders one or more products or services, step 1832. Gateway/processor is then notified of the sales transactions, step 1834.

Gateway/processor 1824 determines whether the department store (retail establishment) 1818 selected by customer 1810 is a member of the overseer network, step 1836. If not, customer 1810 is informed, step 1838, so that he can select another retail establishment 1816 from which to purchase his goods or services, step 1830.

If, however, the selected retail establishment 1818 is a member of the overseer network, step 1836, customer 1810 may visit the location of that retail establishment 1818 to pay for the ordered goods and services and receive them, step 1840. Some or all of the information received by gateway/processor 1824 is then periodically communicated to the overseer network.

Customers may view any or all of his transactions at any time by accessing the overseer network via the Internet.

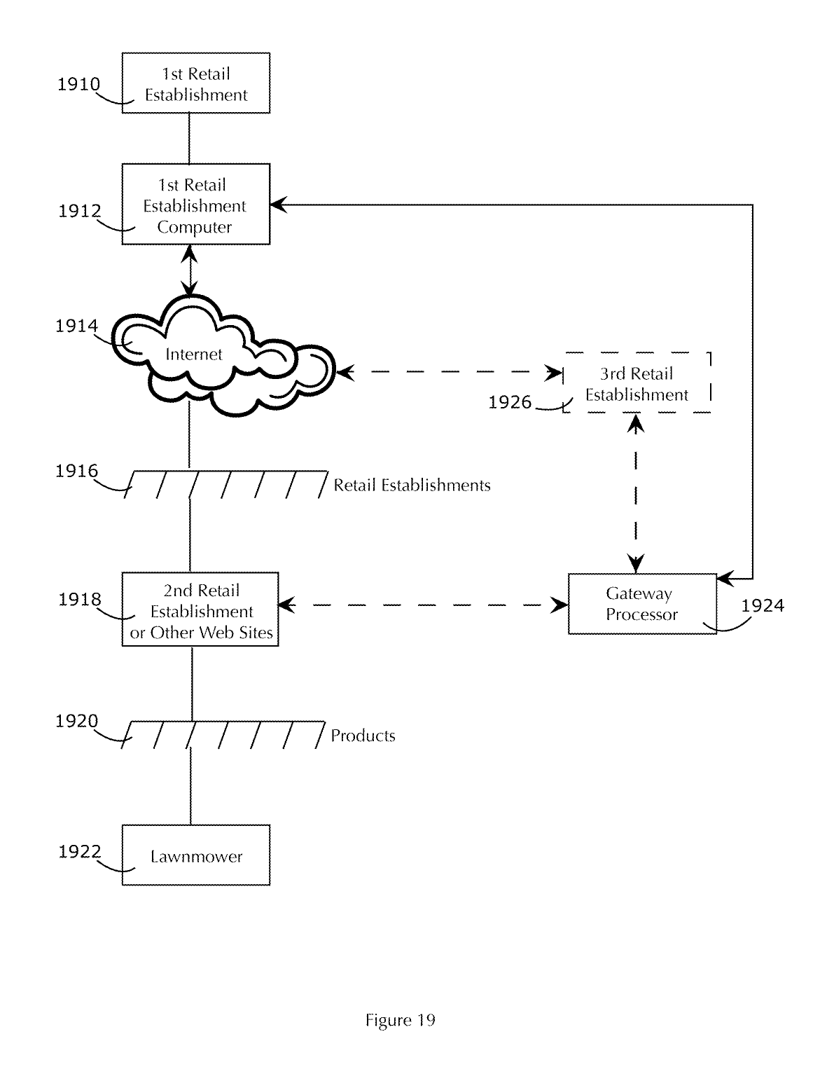

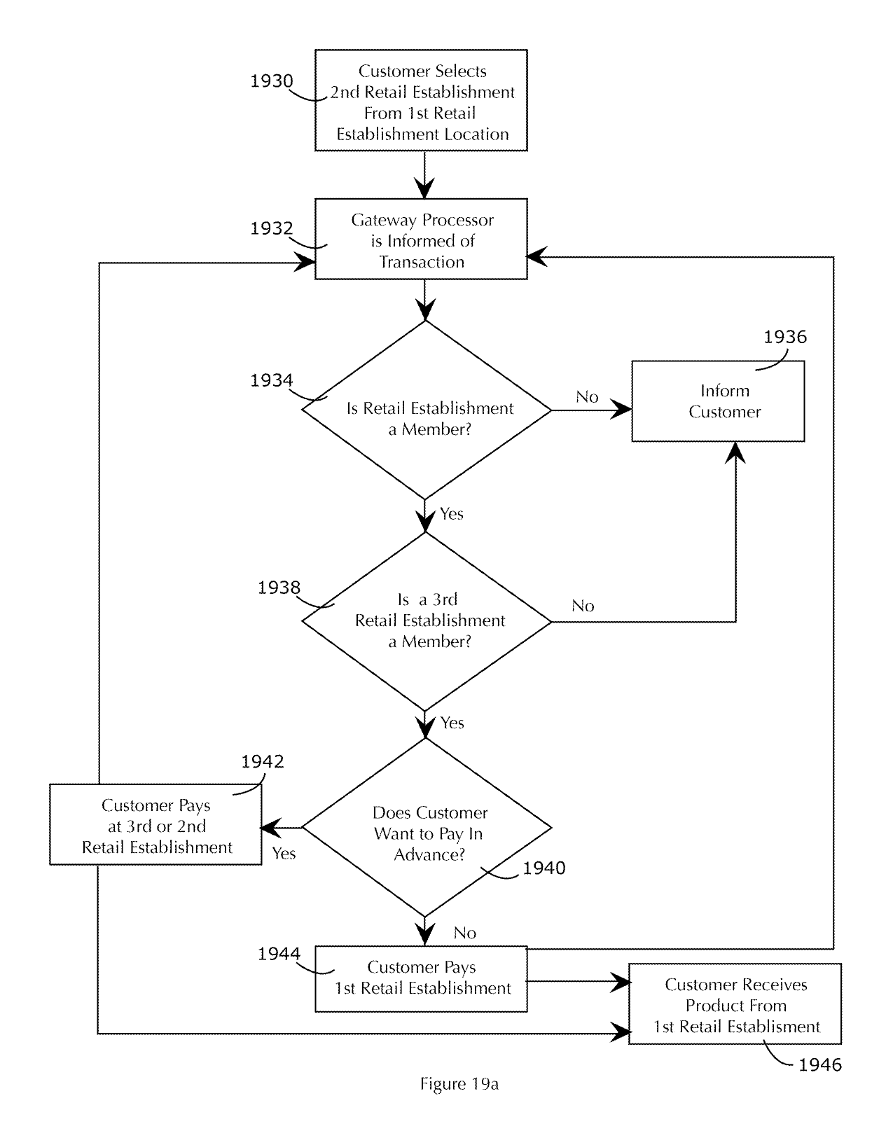

Referring now to FIG. 19, there is shown a block diagram for describing another embodiment of the invention in which a customer may purchase goods or services. A first retail establishment 1910 having a computer 1912 connected to the Internet 1914 is accessible thereby to a number of retail establishments 1916 whose web sites are registered with the Internet, as is well known in the art.

From the listing of retail establishments 1916, the customer may select a second retail establishment 1918 from which to purchase goods or services. Once again, the selected retail establishment 1918 includes a listing of its products or services 1920. For purposes of this example, one of the products 1920 is a lawnmower 1922. Presumably, the customer seeks to purchase lawnmower 1922 from the second retail establishment 1918 via the Internet 1914.

A gateway and/or a processor 1924 is connected to the first retail establishment computer 1912 and the second retail establishment 1918 or, more likely, to point of sale (POS) machine(s) therein.

A third retail establishment 1926, representing any number of retail establishments beyond the aforementioned first and second retail establishments 1910, 1918, respectively, is also optionally connected to the Internet 1914 and to gateway/processor 1924.

Referring now also to FIG. 19a, there is shown a flow chart of operations relating to the block diagram of FIG. 19. A customer first selects a second retail establishment online, step 1930, from the location of a first retail establishment or from his computer or PDA, all of which are connected to the Internet 1914 (FIG. 19) and to gateway/processor 1924, which is informed of the transaction, step 1932. Customer can purchase goods or services from a number of web sites or retail establishments, not merely from the second retail establishment illustrated on FIG. 19. Gateway/processor 1924 determines whether one or both retail establishments are members of the overseer network, step 1934. If not, the customer is informed, step 1936, so that he can select another retail establishment to visit or from which to purchase his goods or services, 1910, 1918, respectively.

If, however, both retail establishments 1910, 1918 are members of the overseer network, step 1934, the customer may decide to pay for his goods or services at a third retail establishment 1926, pending an affirmative determination regarding whether the third retail establishment 1926 is also a member of the overseer network, step 1938. If the third retail establishment 1926 is not a member of the overseer network, step 1938, the customer is so informed, step 1936.

If, however, the third retail establishment 1926 is a member of the overseer network, step 1938, customer can decide whether to pay for his ordered products or services in advance, step 1940, at the location of either second or third retail establishments 1918, 1926, respectively.

However, if the customer declines to pay in advance, step 1940, he can pay at the location of the first retail establishment 1010, step 1944, and receive his goods or services thereat, step 1946. Once again, some or all of the information received by gateway/processor 1924 is then periodically communicated to the overseer network, which is accessible to the customer once the transaction is completed.

It can be seen that, by selecting a first retail establishment from the location of a second retail establishment, and if a third retail establishment is a member of the overseer network, the customer may pay for any or all of the ordered goods or services from any one of the first, second, or third retail establishments and receive his goods or services—or have them shipped—from the first retail establishment.

In order to facilitate commercial transactions that may use POS machines between the gateway/processor 1824 (FIGS. 18) and 1924 (FIG. 19) and retail establishments, a security code is needed. This code can be used by a customer for a number of purposes, including confirmation that a purchase has occurred, that the customer qualifies for a contest, and that the customer may download one or more entertainment products either through the Internet or from retail establishments.

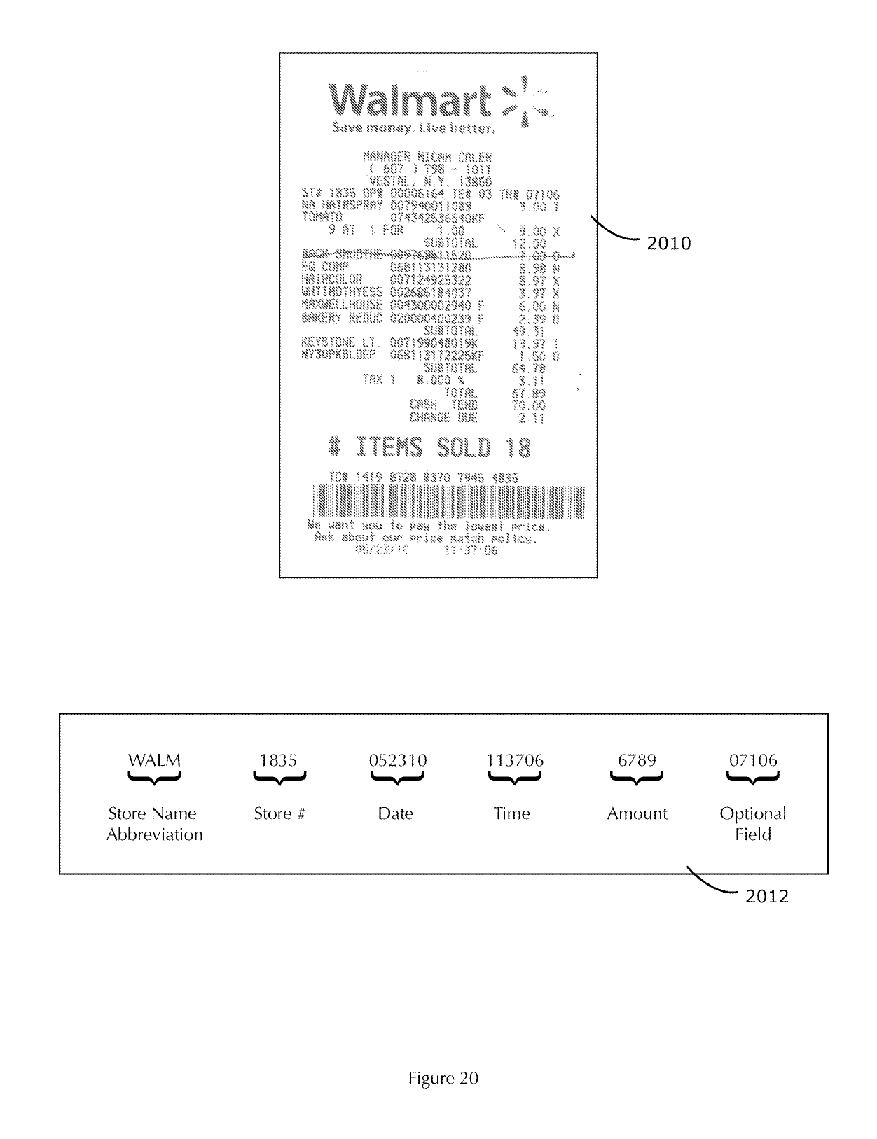

Referring now also to FIG. 20, a security code in addition or in lieu of the code described hereinabove with respect to FIG. 16, is generated by using one or more pieces of information located on a standard printed receipt 2010. This information is also stored at the gateway processor, merchant accounts, banks and, of course the retail establishment from which goods and services have been purchased. The code system serves as a backup, matching the data files and information and indicating that a transaction accrued. This code system ensures that the customer confirms his order and helps prevent fraud. The fields 2012 used to construct the security code include but are not limited to: store name or abbreviation thereof, store number, date, time, amount of sale, and any number of optional fields, such as terminal number, zip code, address, phone number, etc. Any number of letters, numbers, and symbols can be used. The information located in each field 2012 can be concatenated in any order, not necessarily the order that appears in FIG. 20.

Fields 2012 that form the code are preferably printed on receipt 2010 in human readable form so the customer can use his code to track his transaction and ensure that the product actually belongs to the customer. An optional bar code, representative of the details of the transaction can also be printed on receipt 2010.

Since other modifications and changes varied to fit particular operating requirements and environments will be apparent to those skilled in the art, this invention is not considered limited to the example chosen for purposes of this disclosure, and covers all changes and modifications which does not constitute departures from the true spirit and scope of this invention.

Having thus described the invention, what is desired to be protected by Letters Patent is presented in the subsequently appended claims:

1. A method for facilitating commerce by the use of an overseer network, the steps comprising:
a) allowing a customer to select a retail establishment using a worldwide online site from which to purchase at least one of the group: goods and services;
b) allowing said customer to order via said worldwide online site at least one of the group: goods and services;
c) informing an overseer network of the transaction performed in step (b);
d) determining by comparing a list operatively connected to said overseer network whether said retail establishment is a member thereof; and
e) allowing said retail establishment to transfer an ordered good or service to said customer and receive payment therefor.

2. A method for facilitating commerce by the use of an overseer network, the steps comprising:
a) allowing a customer to select a first retail establishment using a worldwide online site from the location of a second retail establishment to order at least one of the group: goods and services;
b) determining by comparing a list operatively connected to said overseer network whether both of said retail establishments are members of said overseer network;
c) determining by comparing a list operatively connected to said overseer network whether a third retail establishment is a member of said overseer network;
d) allowing said customer to pay for at least a portion of said ordered goods or services at any one of the group: said first retail establishment, said second retail establishment, and said third retail establishment; and
e) informing said overseer network of the transaction performed in step (d).

3. The method for facilitating commerce by the use of an overseer network in accordance with claim 2, the steps further comprising:
f) allowing said first retail establishment to transfer an ordered good or service to said customer.

4. The method for facilitating commerce by the use of an overseer network in accordance with claim 2, the steps further comprising:
f) generating a security code at a point of sale (POS) station, related to said transaction and informing said customer via a worldwide online system thereof.

5. The method for facilitating commerce by the use of an overseer network in accordance with claim 4, wherein said security code is constructed for each transaction and formed by acquiring data printed on a register receipt and concatenating at least a portion thereof.

6. The method for facilitating commerce by the use of an overseer network in accordance with claim 4, the steps further comprising:
g) conducting at least one contest via a worldwide online system for a customer based on information associated with said security code.

7. A method of constructing a security code using information derived from sales of goods or services, the steps comprising:
a) at a point of sale (POS) station, acquiring data printed on a register receipt; and
b) concatenating at least a portion of said data to form a security code.

8. The method of constructing a security code using information derived from sales of goods or services in accordance with claim 7, wherein said data comprises at least one from the group: store name or abbreviation thereof, store number, date, time, amount of sale, and optional field.

9. The method of constructing a security code using information derived from sales of goods or services in accordance with claim 8, wherein said optional field comprises data representative of at least one of the group: terminal number, zip code, address and phone number.

10. The method of constructing a security code using information derived from sales of goods or services in accordance with claim 9, the steps further comprising:
c) conducting at least one contest via a worldwide online system for a customer based on information associated with said code.

11. The method of constructing a security code using information derived from sales of goods or services in accordance with claim 9, further comprising:
c) qualifying a customer to participate in at least one contest.

12. A system for facilitating commerce by the use of an overseer network, comprising:
a) a first retail establishment having Internet access and being operatively connected to a first gateway;
b) a second retail establishment having Internet access and being operatively connected to a second gateway;
c) means for determining whether both of said retail establishments are members of an overseer network;
d) a third retail establishment having Internet access and being operatively connected to said third gateway; and
e) means for allowing a customer to pay for at least a portion of ordered goods or services at any one of the group: said first retail establishment, said second retail establishment, and said third retail establishment.

13. The system for facilitating commerce by the use of an overseer network in accordance with claim 12, further comprising:
f) means for generating a security code at a point of sale (POS) station related to said transaction and informing said customer thereof.

14. The system for facilitating commerce by the use of an overseer network in accordance with claim 13, wherein said security code is constructed for each transaction and formed by acquiring data printed on a register receipt and concatenating at least a portion thereof.

15. The method of constructing a security code using information derived from sales of goods or services in accordance with claim 14, wherein said data comprises at least one from the group: store name or abbreviation thereof, store number, date, time, amount of sale, and optional field.

16. The method of constructing a security code using information derived from sales of goods or services in accordance with claim 15, wherein said optional field comprises data representative of at least one of the group: terminal number, zip code, address and phone number.

17. The system for facilitating commerce by the use of an overseer network in accordance with claim 13, further comprising:
g) means for conducting at least one contest via a worldwide Internet system for said customer based on information associated with said security code.
